(19) United States
(12) Patent Application Publication
(10) Pub. No.: US 2008/0109889 A1
(43) Pub. Date: May 8, 2008

(54) Methods, systems and devices for securing supervisory control and data acquisition (SCADA) communications

(76) Inventor: Andrew Bartels, Scottsdale, AZ (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/980,851

(22) Filed: Oct. 31, 2007

Related U.S. Application Data
(63) Continuation-in-part of application No. 11/713,314, filed on Mar. 2, 2007.
(63) Continuation-in-part of application No. 10/869,217, filed on Jun. 15, 2004.
(60) Provisional application No. 60/778,207, filed on Mar. 2, 2006.
(60) Provisional application No. 60/484,383, filed on Jul. 1, 2003.
(60) Provisional application No. 60/904,457, filed on Mar. 2, 2007.

(51) Int. Cl. G05B 15/02; G06F 21/00

(52) U.S. Cl. 726/7; 700/9

(57) ABSTRACT

A secure supervisory control and data acquisition (SCADA) system is presented. The inventive system includes a SCADA control host system configured to process SCADA information, and at least one remote device configured to communicate SCADA information with the control host system. The inventive system further includes a modem coupled between the at least one remote device and a communication line, wherein the modem is configured to allow for communication between the remote device and the communication line. The system further includes a security module coupled between the modem and the remote device. The security module is configured to control access to the remote device by a user seeking access thereto from the communication line through the modem.

### CROSS REFERENCE TO RELATED APPLICATIONS

This application is a Continuation-in-Part of and claims priority to currently pending U.S. patent application Ser. No. 11/713,314 entitled “Methods, Systems and Devices for Securing Supervisory Control and Data Acquisition (SCADA) System” filed on 2 Mar. 2007, which claimed the benefit of U.S. Provisional Patent Application No. 60/778,207 entitled “Method, Systems and Devices for Securing Supervisory Control and Data Acquisition (SCADA) Communications” filed on 2 Mar. 2006, and which was also a Continuation-in-Part of and claimed priority to U.S. patent application Ser. No. 10/869,217 entitled “Method, Systems and Devices for Securing Supervisory Control and Data Acquisition (SCADA) Communications” filed on 15 Jun. 2004, which, in turn, claimed the benefit of U.S. Provisional Patent Application No. 60/484,383 filed on 1 Jul. 2003.

This application also claims the benefit of U.S. Provisional Patent Application No. 60/904,457 filed 2 Mar. 2007 and entitled “Method, Systems and Devices for Securing Supervisory Control and Data Acquisition (SCADA) Communications.”

Each of the above referenced applications is hereby incorporated by reference in their entirety.

### BACKGROUND OF THE INVENTION

1. Technical Field

The present invention generally relates to supervisory control and data acquisition (SCADA) systems, and more particularly to systems, techniques and devices for securing communications within a SCADA environment.

2. Discussion of the Related Art

Supervisory control and data acquisition (SCADA) systems are computer-based systems used for gathering data and/or for controlling industrial systems in real time. SCADA systems are frequently used to monitor and control industrial equipment and processes in such industries as telecommunications, manufacturing, water and waste control, energy generation and distribution, oil and gas refining, transportation and the like. At present, approximately 350,000 SCADA systems are installed in the United States, with many of these systems being used to monitor and control such important infrastructure components as the power grid, water and sewer systems, factories, dams and many others.

A conventional SCADA system includes a central monitoring station (CMS) or other host that communicates with multiple remote stations via a communications network. Each remote station is typically affiliated with a sensor, controller or other field instrumentation for gathering data or affecting some aspect of the controlled system. Examples of conventional sensors include sensors for monitoring the temperature, pressure or flow rate of a gas or fluid, for example, whereas exemplary control instrumentation includes switches, valves, actuators and the like. Data observed from the various sensors is provided to the host, which typically processes the data and responds to user inputs to create control signals that can be used to alter the controlled system via control instrumentation.

More recently, concerns have arisen as to the security of SCADA communications. Because SCADA is used in many highly-sensitive environments, it is feared that SCADA systems could be exploited by terrorists or other unscrupulous individuals to create chaos, industrial accidents or other maladies. SCADA systems were not typically designed to be highly secure, meaning that such systems may be susceptible to tampering, overloading, hostile control or the like. Examples of attacks that could conceivably be mounted on SCADA implementations include overwhelming the relatively low-power transmitters used in such systems with higher power signals, mounting “replay attacks” wherein previously-sent data packets are digitally recorded and re-sent at an inappropriate time, or gaining control of some or all of a SCADA system by reverse engineering SCADA protocols, many of which are available to the public for little or no cost.

Accordingly, it is desirable to create systems, devices and techniques for securing SCADA communications, particularly SCADA systems used to monitor and control infrastructure elements. In addition, it is desirable to formulate secure systems, devices and techniques in a manner that allows for convenient adoption in existing SCADA environments. Other desirable features and characteristics will become apparent from the subsequent detailed description and the appended claims, taken in conjunction with the accompanying drawings and this background material.

### SUMMARY OF THE INVENTION

A secure supervisory control and data acquisition (SCADA) system is presented. The inventive system includes a SCADA control host system configured to process SCADA information, and at least one remote device configured to communicate SCADA information with the control host system. The inventive system further includes a modem coupled between the at least one remote device and a communication line, wherein the modem is configured to allow for communication between the at least one remote device and the communication line. The system further includes a security module coupled between the modem and the remote device. The security module is configured to control access to the remote device by a user seeking access thereto from the communication line through the modem. A method of securing the above described SCADA system, as well as other apparatus and methods corresponding to other embodiments of the SCADA system are also provided.

### BRIEF DESCRIPTION OF THE DRAWINGS

Various aspects of the present invention will hereinafter be described in conjunction with the following drawing figures, wherein like numerals denote like elements, and:

FIG. 1 is a block diagram of an exemplary secure SCADA system;

FIG. 2 is a block diagram of an exemplary host security device;

FIG. 3 is a block diagram of an exemplary remote security device;

FIG. 4 is a flowchart of an exemplary process for operating a secure SCADA system;

FIG. 5 is a data flow diagram of an exemplary process for authenticating remote security devices in a secure SCADA system;

FIG. 6 is a data flow diagram of an exemplary process for initiating secure communications in a secure SCADA system;

FIG. 7 is a data flow diagram of an exemplary process for entering a pass-through mode of a secure SCADA system;

FIG. 8 is a block diagram of an exemplary data structure for secure or unsecure SCADA communication;

FIG. 9 is a flowchart of an exemplary process for encrypting data in a secure data communications environment;

FIG. 10 is a block and data flow diagram of an exemplary host security device configured to compress certain data flowing therethrough;

FIG. 11 is a block and data flow diagram of a portion of an alternate embodiment of the host security device of FIG. 10;

FIG. 12 is data flow diagram of an exemplary process for compressing data in a SCADA system;

FIG. 13 is a block diagram of an exemplary data structure for compressed data in a SCADA system;

FIG. 14 is a block and data flow diagram of an alternate exemplary embodiment of the SCADA system of FIG. 1;

FIG. 15 is a flow diagram of the authentication required in the SCADA system of FIG. 14;

FIG. 16 is data flow diagram of an exemplary process for authenticating a remote security device and a security module in the SCADA system of FIG. 14; and

FIGS. 17 and 18 are data flow diagrams of an exemplary process of authenticating a user seeking access to certain portions of the SCADA system of FIG. 14.

FIG. 19 is a block and flow diagram of another alternate exemplary embodiment of the SCADA systems of FIGS. 1 and 14.

FIG. 20 is a data flow diagram of an alternate exemplary process of authenticating a user seeking access to certain points of the SCADA system of FIG. 19.

FIG. 21 is a block and flow diagram of yet another alternate exemplary embodiment of the SCADA systems of FIGS. 1, 14 and 19.

FIG. 22 is a data flow diagram of another alternate exemplary process of authenticating a user seeking access to certain portions of the SCADA system of FIG. 21.

### DETAILED DESCRIPTION OF PREFERRED EMBODIMENTS

The following detailed description is merely exemplary in nature and is not intended to limit the invention or the application and uses of the invention. Furthermore, there is no intention to be bound by any theory presented in the preceding background of the invention or the following detailed description of exemplary embodiments.

According to various exemplary embodiments, SCADA systems are made more secure by providing an additional security module for each SCADA component. The security module suitably creates a secure connection with one or more other security modules using authentication and/or cryptographic techniques. After the secure connection is in place, the security module encrypts SCADA information sent from the component to the network prior to transmission, and conversely decrypts secure data received from the network. In various further embodiments, the cryptographic techniques used are independent of the underlying SCADA information being transmitted, thereby allowing many of the techniques, systems and devices described herein to be readily applied in conventional SCADA implementations without significant modification. Moreover, by placing a master encryption/decryption module at the SCADA control host, users can actively monitor the entire SCADA network in a secure manner, as described more fully below.

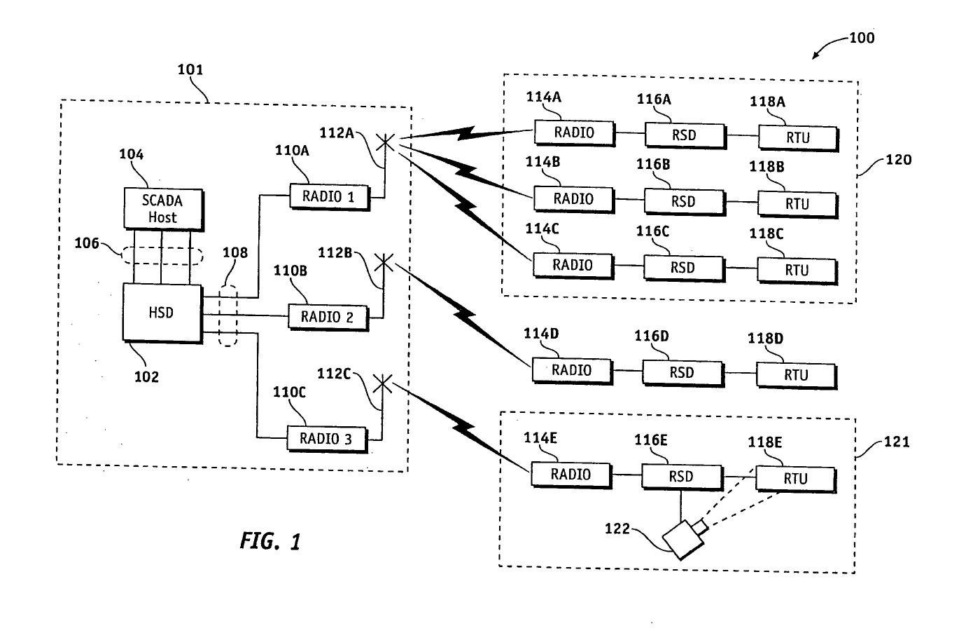

Turning now to the drawing figures and with initial reference to FIG. 1, an exemplary SCADA system/environment 100 suitably includes a SCADA control host system 101 that communicates with any number of SCADA remote terminal unit systems 121 to obtain sensor data, to provide control instructions and/or for other purposes. Both host system 101 and remote systems 121 include security devices 102, 116 (respectively) that encapsulate SCADA information within secure data structures, thereby preventing unauthorized interception, monitoring or tampering.

SCADA control host system 101 suitably includes a SCADA control host 104 connected to a host security device (HSD) 102 via one or more data connections 106. HSD 102 is in turn connected to one or more transceivers 110A-C via secure data connections 108 as appropriate.

Each transceiver 110A-C communicates with one or more remote transceivers 114A-E via any hardwired, wireless or other network. In the exemplary embodiment shown in FIG. 1, host transceivers 110A-C are connected to antennas 112A-C for communicating with remote transceivers 114A-E via wireless links, although alternate embodiments may make use of any digital and/or analog communications media, including satellite links, radio frequency (RF) communications, telephone connections, local and/or wide area data networks, or any other communications media. Accordingly, transceivers 110A-C (as well as remote transceivers 114A-E) may be implemented with any type of RF transmitter/receiver, network interface, radio, modem or other communications device depending on the particular network implementation.

SCADA control host 104 is any host, server or other computing center capable of processing SCADA information. SCADA control host 104 may be implemented on any computing platform, including any workstation, personal computer or the like running any operating system, or may be implemented using specialized hardware and/or computing environments. Control host 104 typically includes software modules and/or processing routines for receiving sensor data and/or user inputs, for processing the data and inputs to determine appropriate control signals, and for providing the control signals to the appropriate remote instrumentation using the network structures described above. Many different implementations of SCADA control hosts 104 are available from various suppliers.

The various data communications between SCADA host 104 and RTUs 118A-E are referred to herein as “SCADA information.” SCADA information processed and transmitted by control host 104 may be formatted in any manner. A number of conventional SCADA protocols including the MODBUS and DNP3 protocols, for example, are described in publicly-available documents. Many products using these and other open or proprietary SCADA protocols and formats are available from many different commercial sources. As described further below, secure communications in SCADA system 100 are provided by HSD 102 and by RSDs 116A-E, allowing secure communications that are not dependent upon the underlying SCADA protocols. Indeed, security may be implemented in a manner that is transparent to SCADA host 104 and remote units 118A-E, thereby allowing wide application across a diverse array of existing and subsequently developed SCADA systems 100.

To that end, HSD 102 is any device, processing card, software application or other module capable of transparently encrypting and decrypting SCADA information to thereby establish secure communications between SCADA control host 104 and one of more remote terminal systems 121. HSD 102 may be further configured to authenticate RSDs 116A-E prior to establishing secure communications, and may additionally provide various control instructions to RSDs 116A-E, including instructions to update software, to reboot, to disable secure communications and/or the like, as described more fully below.

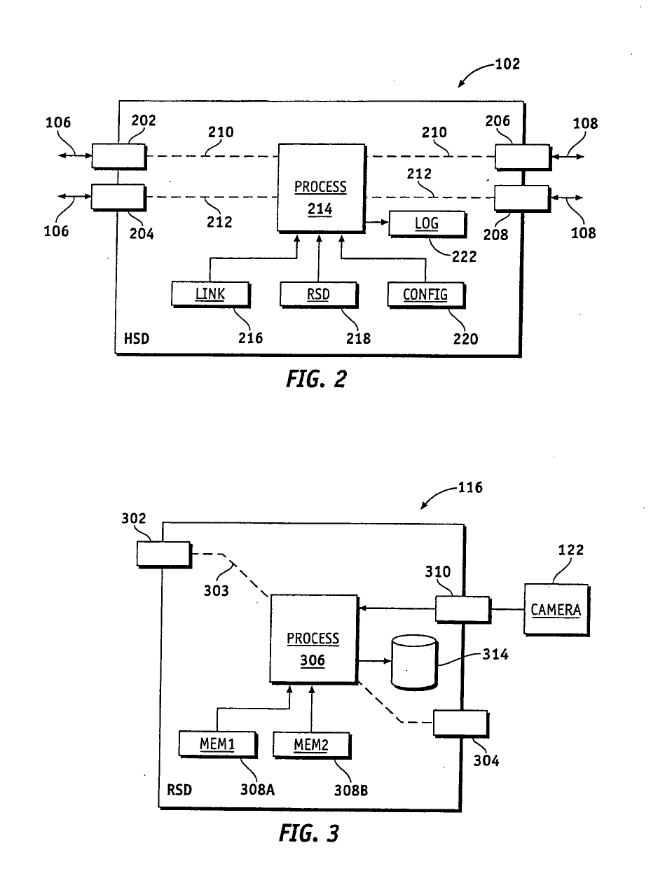

HSD 102 is generally implemented as a passive hardware and/or software module that is capable of encapsulating SCADA information within a secure dataframe without impacting the rest of SCADA network 100. Although HSD 102 is shown as a separate device from SCADA host 104, this distinction is intended as logical in nature. The various functions associated with HSD 102 may be implemented in hardware, software and/or any combination of hardware and software, and in practice may be physically implemented within the same computer or other processing device as SCADA host 104. An exemplary HSD 102 is described in additional detail in conjunction with FIG. 2 below.

Data connections 106 and 108 coupling HSD 102 to SCADA host 104 and transceivers 110A-C, respectively, may be implemented in any manner. In various embodiments, these connections are logical connections over a bus or other communications structure within a common computing host or other device. Alternatively, connections 106 and 108 may be serial, parallel or other connections as appropriate. Examples of serial technologies that could be used in various embodiments include conventional RS-232 serial, universal serial bus (USB), IEEE 1394 (“Firewire”) and the like, although other embodiments may use any other type of open or proprietary communications schemes.

Each remote terminal system 121 suitably includes a remote terminal unit (RTU) 118, a remote security device (RSD) 116 and a transceiver 114 as discussed above. RTU 118A-E is any conventional SCADA remote station, including any type of RTU, programmable logic controller (PLC) or the like. Typically, RTU 118 is a ruggedized computer system capable of communicating with a sensor, valve, switch or other type of field instrumentation to implement a desired SCADA monitoring or control function. Various standard and proprietary implementations of SCADA RTUs 118 are commercially available from a variety of vendors. Transceivers 114A-E are similarly implemented with any type of conventional wired or wireless communications equipment as described above. Although not shown in FIG. 1, transceivers 114A-E may interoperate with an internal or externally-connected antenna to facilitate wireless communications as appropriate.

Each RSD 116 is a device, processing card, software application or other module capable of securing communications between one or more RTUs 118A-E and HSD 102. Like HSD 102, each RSD 116A-E is generally implemented as a passive hardware and/or software module that is capable of encapsulating SCADA information within a secure wrapper without impacting the rest of SCADA network 100. Additional detail of an exemplary RSD 116 is presented below in conjunction with FIG. 3.

In various embodiments, remote system 121 further includes one or more optional cameras 122 for obtaining and recording visual information about RTU 118. Still-frame or motion video images may be obtained using camera 122, for example, to further improve the security of remote system 121. In embodiments that include cameras 122, video images may be stored within RTU 118 and/or RSD 116 as appropriate to allow such images to be retrieved and viewed if the RTU is tampered with or damaged. Alternatively, video images may be provided to HSD 102 or SCADA host 104 to aid in remotely monitoring system 121. Cameras may be optionally configured with motion sensors, light sensors or the like to detect movement or human presence in the vicinity of RTU 118 to further improve the efficiency and effectiveness of video security. Again, video security and camera 122 are optional features that may be implemented in certain embodiments, and are not required for the practice of the general concepts set forth herein.

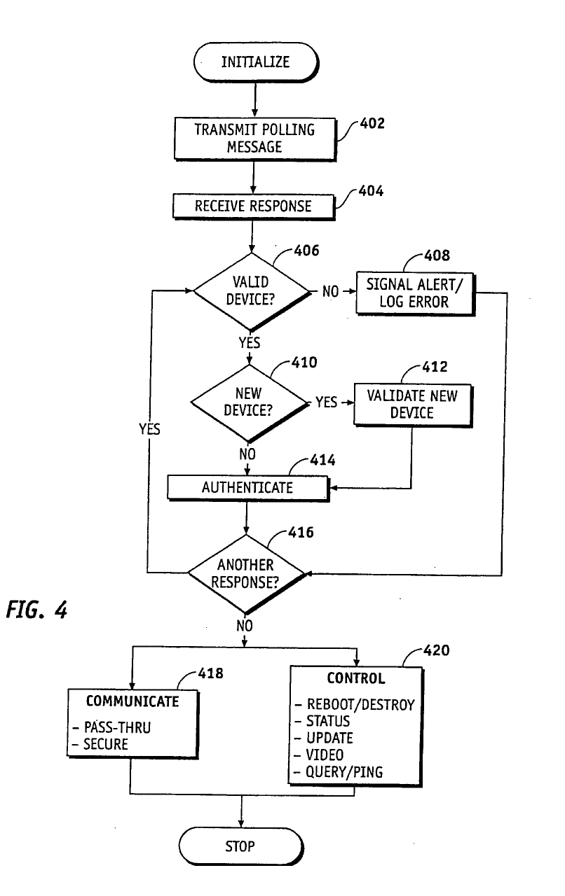

In operation, then, SCADA host 104 communicates with the various RTUs 118A-E to obtain sensor data and to provide control instructions as appropriate, with security devices 102 and 116A-E providing authentication and encryption as desired. Communications may be provided in a secure mode to prevent unauthorized reception or tampering. Further, various embodiments may provide a “pass-through” mode in which encryption is disabled for certain non-secure transmissions, broadcasts or the like. Data communications may be established in a point-to-point manner (e.g., as shown between host transceiver 110B and remote transceiver 114D in FIG. 1), or may be established with multiple remote transceivers 114 tuned to a common radio frequency or otherwise connected in a shared communications configuration to receive broadcasts from a single host transceiver 110, thereby creating a broadcast group 120 (e.g., as shown by host transceiver 110A and remote transceivers 114A-C in FIG. 1). In a broadcast group configuration, each RSD 116 may be individually addressed using any convenient addressing scheme. Further, HSD 102 may communicate with each RSD 116A-C in broadcast group 120 using a cryptographic key that is unique to that RSD, thereby making secure transmissions unintelligible to other RSDs that are not in possession of the unique key. Additional detail about exemplary cryptographic techniques for authenticating and securing communications is provided below in conjunction with FIGS. 4-7, as well as FIG. 9.

Referring now to FIG. 2, an exemplary HSD 102 suitably includes one or more clear interfaces 202, 204, a process module 214 and one or more secure interfaces 206, 208. HSD 102 may be implemented in any manner. As briefly discussed above, HSD 102 may be implemented on a physically distinct computer system from SCADA host 104. An Intel-based personal computing platform running the LINUX operating system, for example, could be used in an exemplary embodiment, although other embodiments may use widely varying hardware and/or software platforms. Alternatively, HSD 102 may be partially or entirely integrated into SCADA host 104 as appropriate. In still further embodiments, HSD 102 is implemented in software running on SCADA host 104.

Interfaces 202, 204, 206 and 208 are any type of actual or virtual interfaces to SCADA host 104 and/or transceivers 110. Such interfaces may be software ports to various other computing processes, for example, or may be implemented with serial or parallel ports within a computing host. In an exemplary embodiment, interfaces 202, 204, 206 and 208 are RS-232 standard serial ports, although other serial or parallel technologies (e.g., USB, IEEE 1394 and the like) could be used in alternate embodiments. It is not necessary that each interface be of the same type; indeed, some or all of the interfaces 202, 204, 206 and 208 may be implemented with unique and varying interface techniques. Moreover, any number of clear and/or secure interfaces could be used in various alternate embodiments, with the number of clear interfaces being equal or unequal to the number of secure interfaces.

Process module 214 suitably creates virtual connections 210, 212 linking clear interfaces 202, 204 and secure interfaces 206, 208 such that data arriving at one interface is processed and output to the other interface in the link, and vice versa. Data passed between the clear and secure interfaces may be simply “passed through” HSD 102 without encryption, or may be encrypted/decrypted depending upon the then-current operating mode of HSD 102. Although FIG. 2 shows virtual connections 210, 212 as connecting each clear interface 202, 204 to a unique secure interface 206, 208, alternate embodiments may create virtual connections that switch, multiplex and/or demultiplex communications between one or more interfaces. Incoming communications from SCADA host 104 may be multiplexed in a one-to-many scheme to multiple transceivers 110, for example, or communications received from one or more transceivers 110 may be directed to multiple SCADA hosts 104 (or multiple ports on a single SCADA host 104) in alternate embodiments.

Process module 214 also communicates with any number of other data sources as appropriate. In the exemplary embodiment shown in FIG. 2, for example, HSD 102 further includes a link table 216, an RSD table 218 and a configuration table 220, as well as a data log 222. Alternate embodiments may include additional, fewer and/or alternate data sources as appropriate. These data sources may be stored in memory or mass storage within HSD 102, or alternatively may be obtained from remote data sources, including memory or mass storage affiliated with SCADA host 104.

Link table 216, for example, may be used to identify port numbers associated with each interface 202, 204, 206, 208, as well as the relationships or mappings between the various ports/interfaces. Link table 216 may also maintain communications parameters for each virtual link, including link data rate, hardware or software flow control parameters, data compression or encryption parameters and/or the like. HSD 102 may also maintain a listing of RSD data 218 with such information as remote device identification data, remote device master key information, assignments to virtual links and the like. HSD 102 may further contain a database or listing 220 of configuration parameters, including default values, timeout and retry settings, or other parameters that apply to the overall HSD 102. Such parameters may be set or updated according to user preferences or other factors. Each table 216, 218 and 220 may be stored in random access memory (RAM) associated with HSD 102, or in any other appropriate location.

Similarly, HSD 102 may be configured to maintain a log 222 in memory, mass storage or another appropriate location. Log 222 suitably maintains information to allow for forensic analysis in the event of a security breach, system crash or other event. Such information may include records of configuration changes and administration events occurring at HSD 102, device ID recognition events (e.g., discovery of invalid devices or valid devices on invalid links, as described below), link activity (e.g., data dumps), cryptography-related packet activity (e.g., for a specific remote device), and/or other information.

HSD 102 may have additional features as well. HSD 102 may provide a graphical or textual user interface, for example, to allow an operator to make configuration changes, to review or retrieve data stored in log 222, or for other purposes. The interface may include user authentication/authorization, including one or more levels of security and associated access privileges. Further, HSD 102 may have a floppy drive, CD ROM drive, network interface, modem interface or the like to allow for data backups, software upgrades, and/or remote access by administrators, service technicians, and/or other approved users.

With reference now to FIG. 3, an exemplary remote security device (RSD) 116 suitably includes a clear interface 304 and a secure interface 302 logically interconnected by a process module 306 that encrypts/decrypts data passing between the two interfaces. RSD 116 may be implemented with a printed circuit board (PCB) or other data processing card, with one or more software modules, and/or with a standalone computing device. In an exemplary embodiment, RSD 116 is implemented with a microcontroller-powered circuit card that is optionally contained within a housing. Again, alternate embodiments of RSDs 116 could be formulated on any hardware and/or software platforms or environments.

RSD 116 suitably includes one or more memory modules 308A-B for storing data and instructions for processing module 306. Memory modules 308A-B may be implemented with any type of static, dynamic or flash memory, for example, or any other type of data storage media. FIG. 3 shows two memory modules 308A-B to facilitate software or firmware upgrades without risk of “crashing” RSD 116 if the upgrade does not complete successfully, although such redundancy is a feature that is not required in all embodiments.

Each interface 302, 304 may be a logical port or actual serial, parallel or other interface for connecting cabling to RTU 118 and/or transceiver 114. In an exemplary embodiment, interfaces 302, 304 are conventional DB-9 or DB-25 RS-232 serial ports, although any other type of serial, parallel or other interface could be used in alternate embodiments. The various interfaces 302, 304 may be configured in any manner, using any convenient data rate, hardware or software flow control, and the like. Further, although FIG. 3 shows RSD 116 as having only a single secure interface 302 and a single clear interface 304, alternate embodiments may include two or more secure and/or clear interfaces as appropriate. Such embodiments may enable RSD 116 to simultaneously support multiple RTUs 118 and/or multiple transceivers 114.

Process module 306 is any hardware and/or software module capable of controlling the various features and functions of RSD 116. In various embodiments, process module 306 suitably maintains virtual connection 303 between secure interface 302 and clear interface 304. Process module 306 also negotiates with the HSD 102 to establish and maintain secure communications, as well as to process any control data as described more fully below. In various embodiments, RSD 116 defaults to a “pass-through” (i.e., unsecure) mode at power-up, and remains in this mode until instructed by an HSD 102 to enter a secure mode. During secure mode, processing module 306 suitably encrypts data received from RTU 118 via clear interface 304 and decrypts data received from HSD 102 via secure interface 302. In various embodiments, processing module 306 reduces latency by providing decrypted data to RTU 118 before RSD 116 fully buffers and verifies that a complete encryption packet has been received. Because large packet data streams may be provided to RTU 118 before the receiving and decrypting processes are complete, RSD 116 is able to very efficiently handle SCADA information with little or no modification to the underlying SCADA protocols. Exemplary cryptographic techniques are described more fully below in conjunction with FIGS. 4 and 9.

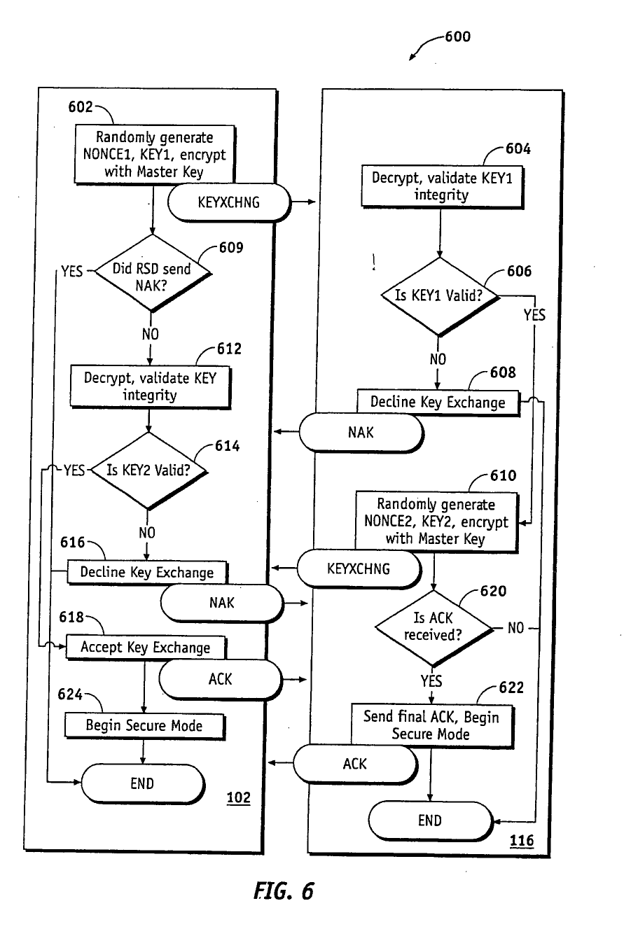

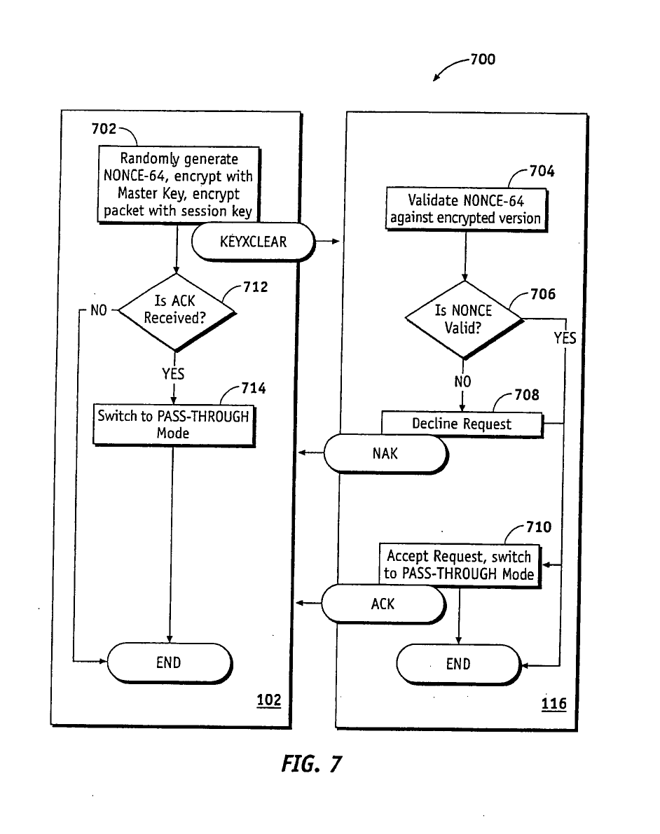

Processing module 306 suitably remains in secure mode until instructed by HSD 102 to return to pass-through mode or until RSD 116 is reset or rebooted. Exemplary techniques for entering secure and pass-through modes are described below in conjunction with FIGS. 6 and 7. Additionally, processing module 306 may continually monitor data passing through virtual connection 303 to identify “host signatures,” polling requests and/or other control messages sent from HSD 102.

Programming for RSD 116 may take place in any manner. In various embodiments, RSD 116 is built on a platform that supports development in any conventional programming language, such as the JAVA programming language available from Sun Microsystems of Sunnyvale, Calif. Security may be further enhanced through the use of dongles, hardware keys or other physical security devices. In such embodiments, the dongle or other device must be physically present in interface 302, interface 304 or another interface in RSD 116 to enable programming, setup, troubleshooting, update or similar features. Insertion of a security device may also trigger a request for a password or other digital credential to further discourage tampering with RSD 116. Software or firmware updates may also be securely processed via HSD 102, as described more fully below.

In a further optional embodiment, RSD 116 may include or communicate with a camera 122 as briefly mentioned above. In such embodiments, camera 122 provides still-frame and/or motion video to RSD 116 via an interface 310, which may be any type of serial (e.g., USB, IEEE 1394, etc.), parallel, optical or other interface as appropriate. Images from camera 122 are suitably provided to RSD 116 for storage in a database 314 and/or for transmittal to HSD 102, SCADA host 104 and/or another appropriate recipient. Camera 122 may be useful to improve the security of RTU system 121 by providing visual images of RTU 118 at regular intervals, in response to a signal from a motion detector or other sensor, or the like.

In operation, then, RSD 116 is suitably inserted between transceiver 114 and RTU 118 in RTU system 121 to secure communications between RTU 118 and HSD 102. As with HSD 102, RSD 116 transparently encrypts and decrypts the underlying SCADA information passing through the device without regard to the underlying protocols and formats, thereby allowing RSD 116 to be readily adapted to any RTU, including legacy equipment.

Turning now to FIG. 4, an exemplary method 400 executable by HSD 102 to establish and process secure communications with any number of RSDs 116 suitably includes the broad steps of broadcasting a polling message (step 402), receiving responses from each RSD 116 (step 404), authenticating the RSDs 116 that respond (step 414), and establishing communications (step 418) and control (step 420) of the various RSDs 116. Further embodiments may contain additional steps as described below.

When HSD 102 is activated (e.g., powered up), processing module 214 suitably transmits a polling message (step 402) to identify RSDs 116 present on each remote link (e.g., the RSDs 116 that are reachable by each secure interface 208). Polling messages may also be transmitted at regular or irregular intervals to identify RSDs 116 that may have come online or dropped offline since the previous polling. Further, polling may be initiated by a human operator via a user interface to HSD 102 and/or SCADA host 104 as appropriate. In various embodiments, the initial polling message could be implemented as a simple “PING” message transmitted to a broadcast address (e.g., 0xFFFF could be arbitrarily chosen as a broadcast address in embodiments with a two byte addressing scheme) to obtain a response from each RSD 116 receiving the “PING.” Alternatively, HSD 102 could send “PING” messages addressed to one or more known RSDs (e.g., RSDs identified in tables 216 or 218) to provoke replies from only certain RSDs 116.

RSDs 116 respond to the polling message in any appropriate manner (step 404). In various embodiments, each RSD 116 sends a reply (“PONG”) message back to HSD 102 in response to the polling (“PING”) request. In other embodiments, RSD 116 determines if response is necessary (e.g., if a response was previously sent to the same HSD 102 within a relatively recent timeframe, or if the RSD 116 is already authenticated with HSD 102), and sends the “PONG” reply only if the HSD needs such information. If a response is necessary, RSD 116 formats a “PONG” message to HSD 102 that includes the address/identification of the RSD 116, as well as any other relevant information (e.g., software version or other data) as appropriate. In further embodiments, RSD 116 waits for a period of predetermined or random period of time prior to transmitting the “PONG” message to prevent simultaneous transmission by multiple RSDs 116. In such embodiments, the PONG response may contain timing information (e.g., the wait time and/or the time of transmission) to allow HSD 102 to calculate link delay times for communications sent to RSD 116.

Upon receipt of a “PONG” message or other reply to the polling query, HSD 102 suitably validates the message (step 406) to determine if the replying RSD 116 is authorized to share SCADA information within system 100. Validation may involve comparing the RSD identification against data stored in RSD table 218 to verify that the responding RSD 116 is authorized to communication within system 100, as appropriate. Additionally or alternatively, HSD 102 compares the RSD identification against data in link table 216 or the like to confirm that RSD 116 is communicating on the proper link (i.e., is associated with a proper broadcast group 120). Validating RSD 116 in this manner prevents unscrupulous users from placing rogue RSDs 116 within the system or from moving legitimate RSDs 116 from one place to another. If a rogue RSD 116 is identified in step 406, HSD 102 suitably provides an alert to an operator (step 408) as appropriate. Alerts may be visual, audible or otherwise in nature, and/or the event may simply be recorded in log 222 for further evaluation at a later time. HSD 102 may perform additional validation to further improve the security of system 100 as appropriate.

HSD 102 may also automatically identify new RSDs 116 (step 410) as appropriate. Although this step is shown distinct from step 406 in FIG. 4, in practice steps 406 and 410 may be combined in any manner. If a new RSD 116 responds to the polling message, the new device may be recognized and validated (step 412) in any appropriate manner. An operator may be prompted to approve the new RSD 116, for example, before allowing the new device to communicate within system 100. Upon validation, entries for the new RSD 116 may be made in data list 218 or elsewhere as appropriate.

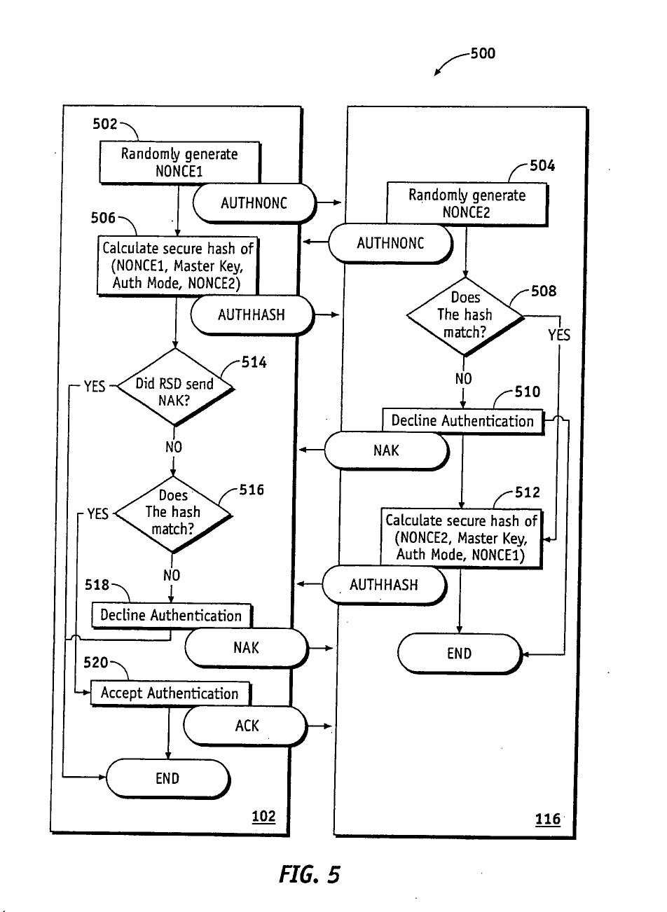

To further improve security, each RSD 116 appropriately authenticates with HSD 102 to further verify that the RSD 116 is authorized to transmit and receive SCADA information within system 100. Authentication involves proving the identity of the RSD 116 by providing a digital signature or other credential from RSD 116 to HSD 102. One technique for authenticating RSD 116 and HSD 102 to each other is described below in conjunction with FIG. 5.

RSD recognition, validation and authentication continues (step 416) until each of the RSDs 116 operating within a broadcast group 120 are identified and processed as appropriate. When an RSD 116 is properly authenticated, data communications proceed as appropriate. Communications may include data packets (step 418) and/or control packets (step 420) for configuring the actions taken by one or more recipient RSDs 116. For standard data communications (step 418), SCADA information between the secure interfaces of HSD 102 and RSD 116 in a secure manner, or in “pass-through” mode. As briefly described above, data transmitted in “pass through” mode is not typically encrypted, but rather is sent “in the clear.” While such transmissions may be susceptible to interception and/or tampering, “pass through” messages may be used to efficiently transmit non-sensitive information and the like. For information sent in secure mode, the transmitting security device appropriately encrypts the SCADA information stream using an appropriate cryptographic technique to prevent interception or tampering during transmission. Although any block or stream cipher could be used to secure data transmitted in this mode, exemplary embodiments make use of conventional stream ciphers such as the RC4, SOBER, SNOW, LEVIATHON or other cryptography algorithms. In other embodiments, block ciphers such as DES, AES or the like may be used. In still further embodiments, SCADA information is encrypted and immediately transmitted upon receipt of SCADA information; that is, the security device does not wait for a complete SCADA message to be received to begin encrypting and transmitting encrypted data. Similarly, received secure data can be readily decrypted and forwarded to the SCADA component associated with the security device before the encrypted data is entirely received at the secure interface. As mentioned above, this immediate processing of received data reduces latency in processing, particularly on large data packets.

Control messages (step 420) may be sent as out-of-band or other messages to provide information, to place a remote security device into a desired operating state, or to provide other instructions to remote security devices as appropriate. In various embodiments, each HSD 102 and RSD 116 scans each message header to identify relevant control messages. Each control message may be formatted according to a pre-defined protocol, with each control data recipient being programmed to recognize and process control data packets as appropriate. Examples of functions that can be carried out by control data packets include information queries (e.g., status requests, “PING” messages and the like), instructions to reboot or reformat a remote device, software/firmware upgrades and the like. In various embodiments, RSDs 116 may be configured to “self destruct” (e.g., to become inoperable, or at least disable secure communication capability) in response to a control data packet encrypted with a particular key or otherwise formatted in an appropriate manner. Control data packets may also be used to request and transfer video images from camera 122, database 314 and/or another source as appropriate. Many other control features could be implemented in a wide array of alternate but equivalent embodiments.

FIGS. 5-9 describe exemplary cryptographic techniques and structures, although any other symmetric, asymmetric or other cryptographic techniques may be used in a wide array of alternate embodiments. With reference now to FIG. 5, an exemplary process 500 for authenticating RSD 116 and HSD 102 to each other suitably includes the broad steps of generating random nonces at HSD 102 and RSD 116 (steps 502, 504), calculating secure hashes as functions of the two nonces (steps 506, 512) and checking that the hashes created by each device match to verify that the remote device is indeed authorized to communicate within system 100 (steps 508, 516). Process 500 suitably verifies that both HSD 102 and RSD 116 are in possession of a “master key,” which is a bit sequence of any length that is unique to an HSD 102 and all RSDs 116 in secure communication with the HSD 102. Alternatively, each RSD 116 may be associated with its own cryptographic key, with a copy of each RSD key being stored with HSD 102. In such embodiments, process 500 verifies that both the HSD and RSD are in possession of the same RSD key as appropriate. In other equivalent embodiments, asymmetric cryptography (e.g., public and private key pairs) could be used.

Authentication process 500 suitably begins with HSD 102 and RSD 116 each generating a random bit stream (steps 502 and 504, respectively). The bit stream may be of any length (e.g., on the order of one to eight bytes), and is referred to herein as a “nonce”. In various embodiments the nonces are approximately thirty-two bits in length, and are randomly generated according to any technique. The nonces are exchanged between HSD 102 and RSD 116 as appropriate.

After receiving the nonce from RSD 116, HSD 102 suitably calculates a hash value using the two nonces and the master key (step 506). The hash is any bit sequence computed as a duplicatable function of the input data. In various embodiments, the hash is a “digest” that verifies the contents of the input data. Various hash and digest algorithms are known in the cryptographic arts, including the SHA-1 algorithm defined in FIPS-186-2, as well as the MD2, MD4 and MD5 described in numerous public resources. The calculated hash is then transmitted from HSD 102 to RSD 116.

Upon receipt of the calculated hash from HSD 102, RSD 116 also computes a hash or digest using the same algorithm and input data used by HSD 102. If the underlying input data (e.g., the two nonces and the master key) processed by RSD 116 and HSD 102 are identical, then the two resulting hashes should be identical to each other (step 508). If the hash calculated by RSD 116 does not match the hash received from HSD 102, then authentication is declined by RSD 116 (step 510) and a negative acknowledgement (“NAK”) message is transmitted to HSD 102. If the two hashes match, however, the RSD 116 has verified that HSD 102 properly received the nonce previously transmitted, that RSD 116 properly received the nonce transmitted by HSD 102, and that the two devices are in possession of the same master key. RSD 116 then processes a second hash using the same input data (e.g., by reversing or otherwise modifying the order of the input data, or by modifying the input data in any other predictable manner) and transmits this second hash to HSD 102 (step 512).

If HSD 102 receives the “NAK” message from RSD 116 (step 514), HSD 102 suitably concludes that authentication did not succeed. If a second hash is received, however, HSD 102 attempts to duplicate the hash using techniques similar to those described above. If the HSD 102 is able to verify the second hash calculated by RSD 116, then authentication is accepted (step 520) and the RSD 116 is trusted or otherwise allowed to communicate within system 100. Alternatively, if the hash is not verified, RSD 116 is not trusted and authentication is denied (step 518). Authentication results may be logged (e.g., in log 222) in any manner, and/or any authentication denials may be flagged or signaled to an operator for subsequent action. Authentication denial could result from rogue devices communicating within network 100, but also could result from communications errors, system malfunctions or other factors that may be investigated as appropriate.

After HSD 102 and RSD 116 are authenticated to each other, secure (and unsecure) communications can take place. With reference to FIG. 6, an exemplary process 600 for initiating secure mode information exchange suitably includes the broad steps of each device generating random nonces and session keys (steps 602, 610), validating the keys generated by the other devices (steps 606, 614), and acknowledging successful validation of the session keys (steps 618, 622). Process 600 allows HSD 102 and RSD 116 to generate and exchange session keys to allow transmission and receipt of encrypted packets.

The transition to secure mode suitably begins with HSD 102 randomly generating a nonce and a session key. Once again, the nonce is a random bit stream of any length that is used to prevent “replay” attacks (i.e., attacks wherein a hostile party “records” digital packets and plays them back at a later time). Since the nonce changes each time the devices enter secure mode, packets replayed at a later time will be invalid after the nonce embedded in the message expires. The session key is any bit stream capable of use as a cryptographic key in sending or receiving secure data. While key formats vary from embodiment to embodiment, exemplary types of cryptographic keys are the result of numerical functions such as elliptical functions, products of prime numbers and the like. After generating a nonce and session key, HSD 102 suitably formats a “key exchange” message that includes the key, the nonce and information that allows the key to be verified by RSD 116. Such information may include a hash, digest or cyclic reduction code (CRC) of the key and/or nonce. In various embodiments, the verification information is a CRC-32 digest of the key. This information is arranged in a suitable format, encrypted with the master key for the HSD 102, and transmitted to RSD 116.

RSD 116 receives the key exchange message from HSD 102 and decrypts the message to extract the session key and nonce (step 604). The key is validated using the validation information contained within the message (step 606) to verify that the proper key has been received. If RSD 116 is unable to validate the key (step 608), a negative acknowledgement (“NAK”) is sent back to HSD 102.

Although not strictly necessary, using separate session keys for transmission and receipt of data further enhances the security of system 100 by making communications interception and tampering much more difficult for a hostile party. Upon successful validation of the HSD session key, then, RSD 116 suitably generates its own key and nonce for the secure session (step 610). The key and nonce are formatted in a key exchange format with validation information and encrypted using the master key. The encrypted message is then transmitted to HSD 102 for further validation and processing.

If HSD 102 receives a “NAK” message from RSD 116 (step 609), secure mode is aborted. If HSD 102 receives a key exchange message from RSD 116, however, the message is decrypted, and RSD key is validated using the CRC or other validation information contained in the message (step 612). If HSD 102 is able to validate the received session key (step 614), then the key is accepted and an acknowledgement message is sent to RSD 116 (step 618). Otherwise, key exchange is declined, a negative acknowledgement (“NAK”) is sent to RSD 116, and processing is terminated (step 618).

When RSD 116 receives an acknowledgement, RSD 116 enters secure mode (step 622) and transmits a final acknowledgement (“ACK”) to HSD 102, which then enters secure mode upon receipt of the acknowledgement (step 624). When both HSD 102 and RSD 116 are operating in secure mode, SCADA information transmitted on each outgoing secure interface (e.g., interfaces 206, 208, 302 in FIGS. 2-3) is encapsulated in a security frame and encrypted as appropriate. Other information (e.g., control information, status requests and other non-sensitive data) may be transmitted without encryption, even when the device is operating in secure mode. Each device suitably uses its generated session key to encrypt data, and the received session key to decrypt data as appropriate. Other embodiments, however, may operate in the opposite manner, using the generated session key as a decryption key and the received key as an encryption key. Again, the various cryptographic techniques described herein may be modified in any manner, and any other techniques may be used with a wide array of equivalent embodiments.

When the RSD 116 is no longer expected to transmit secure data, it may be placed back into pass-through mode using any appropriate technique. With reference to FIG. 7, an exemplary technique 700 for taking an RSD 116 out of secure mode suitably includes the broad steps of generating a “key clear” message (step 702) at HSD 102, validating the message at RSD 116 (step 706), and then returning to pass-through mode (steps 710, 714) as appropriate.

Process 700 suitably begins with HSD 102 formatting a “key clear” message (step 702) that includes a newly-generated random nonce (e.g., a sixty-four bit nonce, or a nonce of any other length). The nonce is appropriately encrypted with the master key, and a message is formatted containing the nonce in both encrypted and non-encrypted format. The entire message is then encrypted with the session key for the secure mode session and transmitted to RSD 116 as appropriate.

Upon receipt of a key clear message, RSD 116 suitably decrypts the message to extract the new nonce (step 704). The encrypted nonce contained in the message is decrypted using the master key, and the resulting nonce is compared to the unencrypted nonce contained in the message to validate the nonce (step 706). If the nonce is valid, RSD 116 accepts the request, switches to pass-through mode, and transmits an acknowledgement (“ACK”) to HSD 102 (step 710). If the RSD 116 is unable to validate the nonce, the pass-through request is denied, a negative acknowledgement (“NAK”) is sent to HSD 102, and communications continue in secure mode (step 708). If HSD 102 receives the acknowledgment (step 712), HSD 102 switches to pass-through mode for communications to that RSD 116. HSD 102 may continue to communicate with other RSDs in system 100 in secure mode, as appropriate. To return RSD 116 to secure mode, new session keys are generated and validated as described above. Accordingly, processes 600 and 700 may be used to “clear” the session keys and create new keys even when continued secure communication is desired. Resetting the session keys on a periodic or a periodic basis improves the security of system 100 by making key interception more difficult, and by shortening the window of opportunity for successful replay attacks.

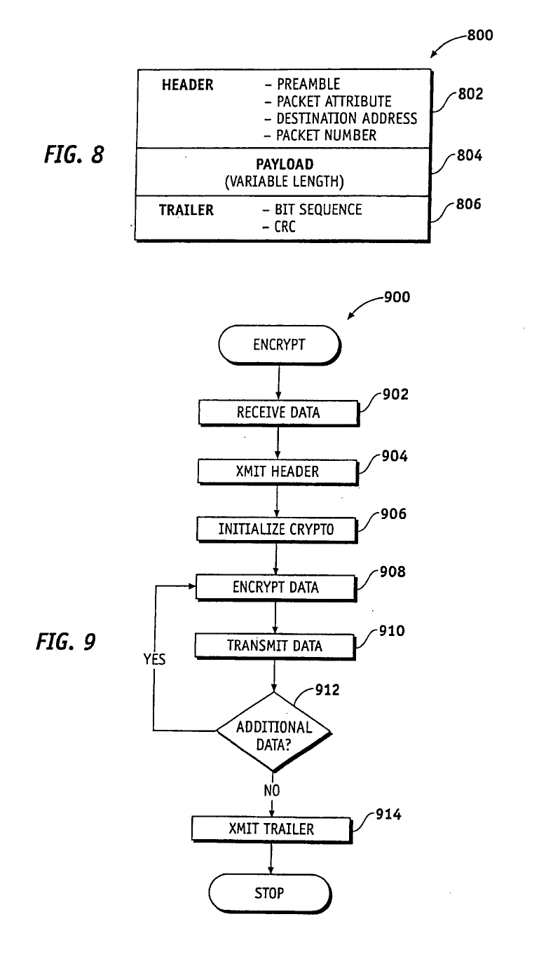

Secure data transmissions may be made within system 100 using any cryptographic and data communications formats. In various embodiments, SCADA information is appropriately encrypted using a stream cipher or the like, and the encrypted data is encapsulated within an appropriate data frame. With reference now to FIG. 8, an exemplary data structure 800 suitable for transmitting encrypted SCADA information suitably includes a header 802, a payload 804 and a trailer 806. Each of these data fields suitably contains digital information that can be exchanged between HSD 102 and any number of RSDs 116A-E.

Data structure 800 may be used with either control packets and/or data packets. In various embodiments, header field 802 and trailer field 806 have a fixed length, with the payload field 804 having a variable length that is dependent upon the amount of data being transmitted. In an exemplary embodiment, header field 802 is defined as having about sixteen bytes of information and trailer field 806 is defined with about four bytes of information, although fields of any length could be used in alternate embodiments.

Header field 802 suitably includes metadata about data structure 800 and/or about data contained within payload field 804. In various embodiments, header field 802 suitably includes a preamble (e.g., a predefined bit sequence that identifies the beginning of a packet), packet attribute data (e.g., two or three bits identifying the packet as a data packet, control packet or the like), an address of a destination (e.g., a one to four byte address of the data receiver; broadcast messages may be sent to a “broadcast address” such as 0xFFFF), and a packet identifier (e.g., a number that indicates the packet's place in a multi-packet data sequence and/or provides an initialization vector for a cryptography engine). An exemplary trailer field 806 suitably includes a CRC, digest or other information to allow verification of data contained within message 800. Trailer field 806 may also include a pre-determined bit sequence that indicates the beginning of the trailer in various embodiments. Other embodiments, however, may incorporate widely varying data formats, with alternative or additional information stored in the packet header 802 and trailer 806.

Referring now to FIG. 9, an exemplary process 900 for encrypting SCADA information for transmission to a remote receiver suitably includes the broad steps of receiving the SCADA information (step 902), transmitting the header field 802 (step 904), encrypting and transmitting the payload data stream 804 (steps 908, 910), and transmitting trailer field 806 (step 914) as appropriate. Alternate embodiments may deviate from process 900 in any manner, and/or may include additional or alternate steps to those shown in FIG. 9.

When SCADA information is received at HSD 102 or RSD 116 (step 902), the security device creates data packets 800 to encapsulate and encrypt bytes of data received at the clear interface. The incoming bytes generally consist of part or all of a packet from the underlying SCADA protocol, although the techniques described herein may be used with any type of information and/or any underlying data formats or protocols.

Upon receipt of SCADA information on the clear interface, the security device appropriately formats a header field 802 as described above (step 904). As noted above, header field 802 appropriately contains meta-data about the packet 800 and/or payload 804, and provides the data recipient with information to allow proper decryption and/or processing of the payload data 804. In various embodiments, header 802 may be provided to the secure interface or otherwise transmitted to the recipient immediately upon receipt of SCADA information, or at least as soon as the security device has enough information about payload field 804 to formulate a suitable header 802. By transmitting header 802 while payload data 804 is still being received/processed, latency in transmission may be significantly reduced.

Prior to processing the packet payload 804, the security device initializes the cryptography engine (i.e., the portion of process module 214 or 306 that allows for digital encryption) as appropriate (step 906). Initialization may involve setting an initialization vector (e.g., corresponding to the packet number contained in header field 802) to provide a seed for random number generation or the like. Although FIG. 9 shows initialization (step 906) taking place immediately after header transmission (step 904), in practice this initialization may take place prior to or simultaneously with header transmission.

When the cryptography engine is initialized, encryption of the payload bytes (step 908) may commence. As noted above, encryption may take place using any technique or algorithm, including any block or stream cipher presently known or subsequently developed. In an exemplary embodiment, bytes of SCADA information are processed as they are received at the clear interface using the encryption algorithm and the session keys described above, and encrypted data is immediately transmitted (step 910) as it becomes available. Again, this immediate transmission reduces latency and overhead associated with the encryption process. Encryption and transmission (steps 908, 910) may therefore process concurrently with data receipt (step 902) until all data is received (step 912).

When all data is transmitted, process 900 suitably concludes by transmitting trailer field 806, which suitably contains a CRC or other representation of the data in message 800 that allows the recipient to verify that the data received is complete and accurate. Due to the variable length of payload data 804, trailer 806 may be transmitted after a timeout period (e.g., after no data is received at the clear interface for a period of time), after a maximum amount of data has been transmitted, and/or according to any other criteria. In an exemplary embodiment, each security device 102, 116 supports a configurable maximum payload size (MPS) for the clear interface. Such a parameter may be stored, for example, in the configuration table 220 shown in FIG. 2, and/or may be implemented as an integral part of the communications protocol. Upon receipt of a maximum amount of payload data, the sending security device appropriately formats and sends a trailer including the CRC, with additional SCADA information being transmitted as a payload 804 in a separate message 800.

In various further embodiments, the recipient maintains a “running” CRC of received data that is compared against received data. When a match is found, the recipient knows that the end of payload data 804 is reached and trailer field 806 has begun. In such embodiments, the transmitting device may verify that the CRC bit sequence does not naturally appear in the data stream, which could result in a false understanding by the receiver that the end of a data packet 800 had been reached. In such cases the data packet may be prematurely terminated (e.g., a trailer 806 transmitted), with the additional data being sent in a follow-up packet 800. The transmitting and/or receiving devices may also check for null packets or other undesirable events that may occur during transmission.

With final reference now to FIG. 1, a new system 100 securely transmits SCADA information and other data between a SCADA host 104 and any number of remote terminal units 118A-E using security modules 102, 116A-E. Each security module 102, 116A-E is logically positioned between the communicating device and a transceiver to allow information to be encapsulated within a secure data framework. Because security is maintained by separate modules, the underlying SCADA information and devices need not be modified, thereby allowing implementation across a wide array of new and legacy systems 100.

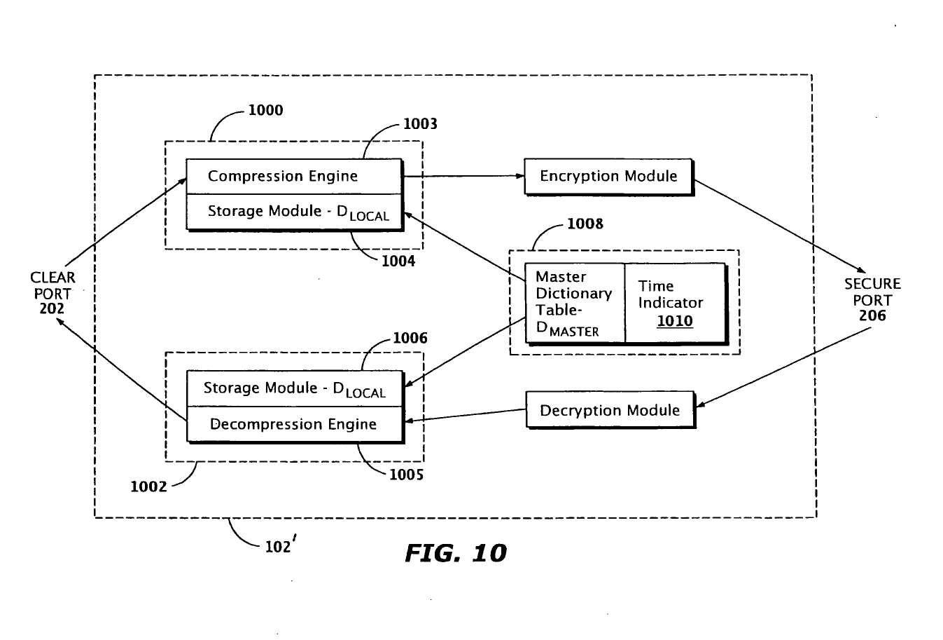

In an alternate exemplary embodiment illustrated, for example, in FIGS. 10-12, the data (i.e., SCADA information) being transferred between control host 104 and RTU(s) 118 is compressed by either HSD 102′ or RSD 116′, respectively, prior to being encrypted, and is decompressed by either RSD 116′ or HSD 102′, respectively, after it is decrypted. Due to the nature of SCADA systems and the desire to have the least possible impact on the system and the data communicated therein, in a preferred embodiment, the data is compressed and decompressed using lossless-type compression techniques. Any number of lossless compression techniques, or derivations thereof, can be employed. For example, known methods/algorithms such as LZW, LZ78, LZ77 and Huffman-type compression may be used. In one exemplary embodiment, a variant of the LZW algorithm is used. In this algorithm, the compressor tunes its compression statistics for all packets that are communicated from HSD 102′ to a particular RSD 116′, and vice versa, taken together as a single data set, as opposed to basing the statistics on the data in a single packet. Accordingly, this algorithm results in the creation of a compression dictionary table (or statistics tree) that optimizes compression, regardless of the length of the individual packets.

With reference to FIG. 10, a general implementation of a compression feature for both HSD 102′ and RSD 116′ is illustrated. This arrangement is generally applicable to both HSD 102′ and RSD 116′, however, for the sake of ease of explanation, the following description will focus on HSD 102′. It should be noted, however, that the following description is equally applicable to RSD 116′. As shown in FIG. 10, HSD 102′ includes compression and decompression modules 1000, 1002 to respectively compress and decompress data passing therethrough. In an exemplary embodiment, compression engine 1000 includes a compression engine 1003 and a storage module 1004. Similarly, decompression engine 1002 includes a decompression engine 1005 and a storage module 1006. Each storage module 1004, 1006 is configured for storing at least a local copy of the particular master compression dictionary table D_{MASTER} being used to compress/decompress the data being passed therethrough. HSD 102′ also includes a static storage module 1008 for storing a master copy of a compression dictionary table D_{MASTER} to be used in compressing the data. For reasons that will be described in greater detail below, master dictionary table D_{MASTER} is further labeled with a time indicator 1010, which, in an exemplary embodiment, takes the form of a sixteen-bit integer.

In operation, data is sent to the clear interface 202 of HSD 102′. Upon receipt of the data, HSD 102′ assembles an uncompressed and non-encrypted packet containing the data. The packet is then transferred to compression module 1000. Prior to compressing the data, compression module 1000 makes a new copy of the master dictionary table D_{MASTER} from static storage module 1008, and saves it in storage module 1004 of compression module 1000 such that compression module 1000 includes a local copy of the master dictionary table D_{MASTER}, which is represented as D_{LOCAL} in storage module 1004. In this instance, table D_{LOCAL} is used by compression engine 1003 to compress the data being transferred from the clear interface 202 to the secure interface 206 of HSD 102′. Once the data is compressed, the compressed packet is encrypted and then sent to secure interface 206 where it is sent to its destination (i.e., RSD 116′ or RTU 118).

Conversely, for compressed data received at secure interface 206 from, for example, RSD 116′, the reverse process occurs. More particularly, after the received data is decrypted, decompression module 1002 makes a new copy of the master dictionary table D_{MASTER} from static storage module 1008, and saves it in storage module 1006 of decompression module 1002 such that decompression module 1002 includes a local copy of the master dictionary table D_{MASTER}, which is represented as D_{LOCAL} in storage module 1006. In this instance, table D_{LOCAL} is used by decompression engine 1005 to decompress the data being transferred between secure interface 206 to the clear interface 202 of HSD 102′. Once decompressed, the data is sent to clear interface 202 where it is then transferred to its ultimate destination (i.e., control host 104).

In order for HSD 102′ and RSD 116′ to successfully communicate compressed data therebetween, each must be compressing and decompressing the data from master compression dictionary tables that have identical time indicator values 1010. Either HSD 102′ or RSD 116′ can inform the other of the time indicator 1010 of its master table D_{MASTER} using a PING/PONG technique similar to that described herein above with respect to the authentication process between HSD 102′ (102) and RSD 116′ (116). Accordingly, in one exemplary embodiment, either HSD 102′ or RSD 116′ can inform the other of its master dictionary table's time indicator by sending a PING packet to the other. Conversely, either HSD 102′ or RSD 116′ can determine the time indicator 1010 of the master dictionary table D_{MASTER} of the other by examining a PONG packet that is sent by the other. Before any compressed packets are sent between HSD 102′ and RSD 116′, HSD 102′ or RSD 116′, depending on which device is sending the packet, must have received the PONG packet from the receiving device, and the time indicators 1010 of the master dictionary tables stored in the respective static storage 1008 of each device must match. It should be noted that these PING and PONG packets are never themselves compressed. It should be further noted that in an exemplary embodiment, only the data being sent as packets (whether data packets or control packets) is compressed. If data is simply being passed through the link (i.e., from clear interface 202 to secure interface 206, or vice versa) without being encapsulated in an encrypted packet, then compression is not applied. Additionally, in an exemplary embodiment, if it is determined that the packets being compressed are actually shorter in length than the compressed packets, the packets will be sent uncompressed.

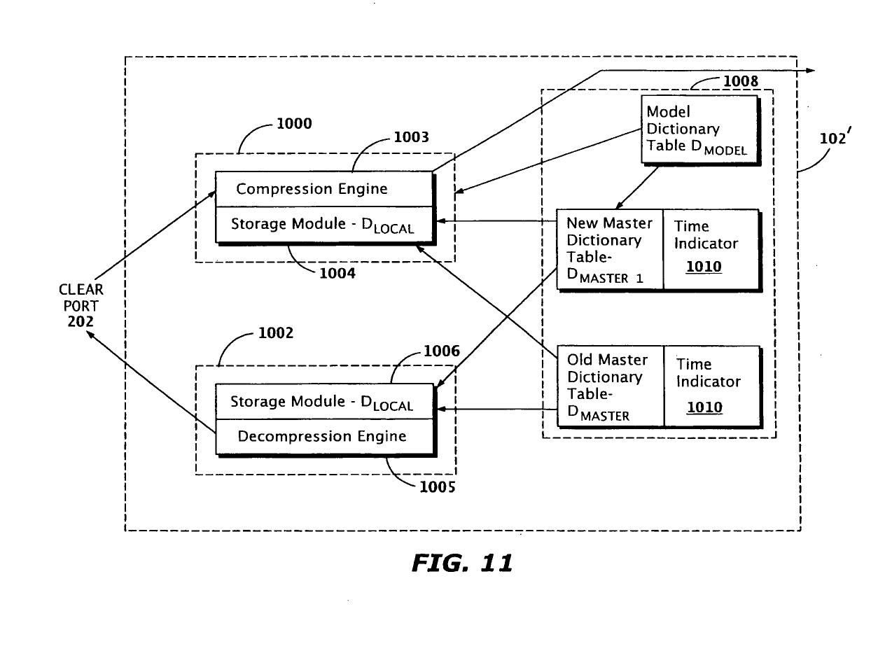

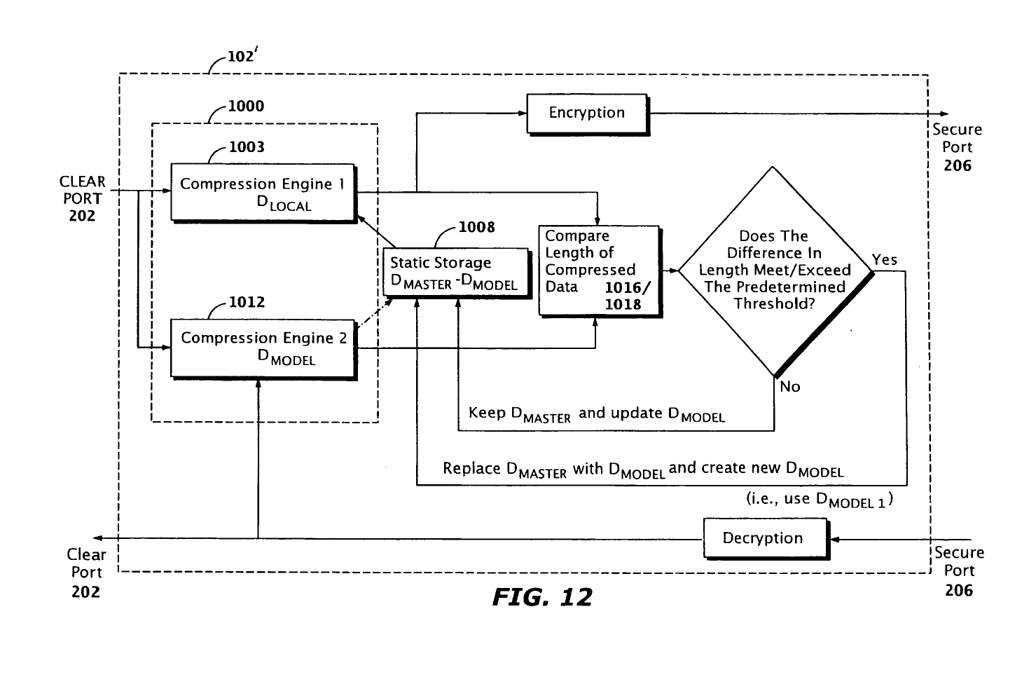

With reference to FIGS. 11 and 12, a more detailed description of the exemplary compression algorithm and an exemplary implementation thereof is illustrated. Once initialized, HSD 102′ reads the compression dictionary table from static storage 1008, which serves as the master dictionary table D_{MASTER}. As described above, HSD 102′ makes a copy of the master table D_{MASTER} before compressing or decompressing each packet. The copy of this table, referred to herein as D_{LOCAL}, is locally stored in the storage module 1004 of compression module 1000. In one exemplary embodiment, when sending the initial PING sequences described above that identify and authenticate the RSD(s) 116′ to HSD 102′, HSD 102′ notes the time indicator 1010 for the master table D_{MASTER} stored in the static memory 1008 of RSD 116′, which is reported back to HSD 102′ in the PONG packet from each RSD 116′ responding to the PING packet. If the HSD 102′ detects that the master table of one or more of the RSDs 116′ has a different time indicator than the time indicator 1010 of the locally stored table D_{LOCAL}, and thus, master dictionary table D_{MASTER}, then it recognizes that a different master compression dictionary table is being used by the particular RSD 116′. In this instance, HSD 102′ initiates a file transfer exchange with the corresponding RSD 116′ to send a copy of the master dictionary table D_{MASTER} stored in static storage 1008 of HSD 102′. Once D_{MASTER} of HSD 102′ is received by RSD 116′, RSD 116′ updates its master dictionary table with the master dictionary table D_{MASTER} sent by HSD 102′, and begins reporting the new and correct time indicator that matches time indicator 1010 in its PING/PONG packets to HSD 102′. Once HSD 102′ receives such a PONG packet, thereby verifying the correct master dictionary table is being used by both devices, uncompressed packets can be compressed by compression engine 1003 and sent by HSD 102′ to RSD 116′, and compressed packets received by HSD 102′ can be decompressed by decompression engine 1005.

Subsequent to the reading of master dictionary table D_{MASTER} stored in static storage 1008 that occurs upon the initialization of HSD 102′, HSD 102′ has the ability to dynamically improve the compression ratio of the system. This is accomplished by HSD 102′ creating “new” or updated master dictionary tables (D_{MASTER1}, D_{MASTER2}, . . . , D_{MASTERN}) to replace prior versions of the master table D_{MASTER} so that data is compressed/decompressed with greater efficiency. In order to do so, HSD 102′ creates a model dictionary table, D_{MODEL}, that is separate from the master dictionary table D_{MASTER}, but that initially has the same contents as D_{MASTER}. However, as will be described in greater detail below, unlike master table D_{MASTER}, which is not updated with each successive compression, model dictionary table D_{MODEL} is continuously updated with each successive compression. To build a better statistics model, HSD 102′ compresses each packet twice, once using compression engine 1003, and once using a second compression engine 1012, which in an exemplary embodiment, is located within compression module 1000. As described above, compression engine 1003 utilizes the local copy (D_{LOCAL}) of master dictionary table D_{MASTER} that is stored in storage module 1004 of compression module 1000. Second compression engine 1012 utilizes the model dictionary table D_{MODEL}, which, in an exemplary embodiment resides in storage module 1008.

With reference to FIG. 12, when data passing through HSD 102′ needs to be compressed, compression engines 1003 and 1012 compress the data using their respective dictionary tables as set forth above. Only the output of compression engine 1000 is provided to the secure interface 206 for transmission to the destination of the data (i.e., RSD 116′ or RTU 118) or may be provided to an encryption module to be encrypted prior to being transmitted to its destination. The output of compression engine 1003 is also compared with the output of the engine 1012. In an exemplary embodiment, this comparison is carried out using two separate counters 1016, 1018. Counter 1016 contains the number of bytes in the compressed output created by engine 1003 using the dictionary table D_{LOCAL}. Counter 1018 contains the number of bytes in the compressed output created by engine 1012 using the dictionary table D_{MODEL}. The compression results (i.e., counters 1016, 1018) are then compared to see whether the model dictionary table D_{MODEL} is performing better than the local master dictionary table D_{LOCAL} (and, therefore, master table D_{MASTER}). In an exemplary embodiment, the model dictionary table D_{MODEL} will be deemed to be performing better if the difference in the length of the two corresponding compressed packets exceeds a predetermined percentage for a predetermined amount of time (i.e., the compressed output of engine 1012 is sufficiently shorter in length than that of the output of engine 1003). In one exemplary embodiment, this predetermined percentage is ten percent (10%) and the predetermined amount of time is thirty minutes. It should be noted, however, that the system can be tuned or adjusted to have different thresholds depending on the application and the requirements thereof. Additionally, in an exemplary embodiment, two additional counters are employed, one for each compression engine, that are configured to count the number of bytes of the decompressed data (i.e., the length of the prior to compression). This allows the system, and HSD 102′ in particular, to determine the compression ratio of each engine by comparing the length of the decompressed data with the length of the respective compressed data output by each compression engine. In one exemplary embodiment, the compression rations can be compared to determine which engine is performing better, and to swap compression dictionaries as described above if the ratios differ by a certain amount.

If the difference in the length of the two corresponding compressed packets does not exceed the predetermined thresholds, then the compression process repeats itself with no change to the master dictionary table D_{MASTER} stored in static storage 1008. Accordingly, when the next packet is presented to compression module 1000 for compression, the local copy D_{LOCAL} of master dictionary table D_{MASTER} is over-written with a new copy of D_{MASTER}, and stored locally in the storage module 1004 of compression module 1000. Therefore, the same master table D_{MASTER} stored in static storage 1008 continues to be used. Compression engine 1003 then uses this local dictionary table to compress and send the data to its destination. Meanwhile, compression engine 1012 continues to use dictionary table D_{MODEL}, which, as briefly described above, is now “smarter” than it was previously since it is updated with each successive compression.

More specifically, unlike master dictionary table D_{MASTER}, model dictionary table D_{MODEL} is not refreshed (i.e., copied and stored locally) after each packet is compressed, but rather is continuously updated with the occurrence and frequency of each repeating string of bits. Similarly, as each compressed packet received by HSD 102′ from, for example, RSD 116′, is decompressed using decompression engine 1005 and the local copy of D_{MASTER} stored therein, the decompressed output is then re-compressed by the second compression engine 1012 using model dictionary table D_{MODEL}. D_{MODEL} is then updated as a result of this “re-compression” of the decompressed data. Additionally, since HSD 102′ already knows the length of the compressed date sent from RSD 116′, by virtue of receiving the compressed data and also knowing and publishing the dictionary table used by RSD 116′ in compressing the data (i.e., D_{MASTER}), the output of compression engine 1002 can be and is compared with the known length of the compressed data sent by RSD 116′ to determine whether D_{MODEL} is performing better than D_{MASTER}. If it is determined that D_{MODEL} is performing better than D_{MASTER}, then D_{MASTER} is replaced with D_{MODEL} as described above. Accordingly, this re-compression of data is carried out for the purpose of building a better model dictionary table D_{MODEL}. Therefore, as time goes on, and with each successive compression and decompression taking place in HSD 102′, D_{MODEL} gets “smarter” than the current master table D_{MASTER}. Thus, a different version of D_{MODEL} (D_{MODEL1}, D_{MODEL2}, . . . , D_{MODELN}) is used for each successive packet being compressed, or re-compressed, as the case may be. As each packet is compressed, the above described comparison is then made and depending on the outcome, the process either repeats itself, as described above, or changes, as described below.

Accordingly, if it is determined that the model dictionary table D_{MODEL} is performing better (as described above), then a new master dictionary table, D_{MASTER1}, is generally created by replacing the previous master dictionary table D_{MASTER} with the current model dictionary table D_{MODEL} (D_{MODEL1}, D_{MODEL2}, . . . , D_{MODELN}, as appropriate). A new model dictionary is then created and set to an initial state such that the “new” D_{MODEL} starts off “dumb” and then gets “smarter” as successive packets are received and compressed, thereby updating itself as described above. Additionally, the respective counters 1016, 1018 are also reset to zero when this change occurs, and the comparison routine repeats itself. Once the new master dictionary table D_{MASTER1} is created, HSD 102′ initiates a file transfer exchange to send the new master table D_{MASTER1} to each RSD 116′ so that compressed data can be successfully communicated and decompressed.

With reference to FIG. 11, while the above described updates to the master dictionary table D_{MASTER} are taking place, HSD 102′ maintains two master dictionary tables, the original or old master table D_{MASTER}, and the new master table D_{MASTER1}. When sending packets to an RSD 116′ that still has the old master table D_{MASTER}, HSD 102′ uses a local copy D_{LOCAL} of the old master table D_{MASTER}. Conversely, when the RSD 116′ to which the packets are addressed has the new master table D_{MASTER1}, a local copy of the new master table D_{MASTER1} is used. Once all of the RSDs 116′ receive the new master table D_{MASTER1}, the old master table D_{MASTER} is discarded. In one exemplary embodiment, HSD 102′ maintains separate new master, old master and model tables for each link in the system (i.e., for each clear interface/secure interface pair). This allows a system having different protocols on different links to optimize overall compression ratios since different tables may be needed for different links. Additionally, in an exemplary embodiment, HSD 102′ is further configured to allow a system administrator to “reset” the compression statistics/tables. This allows the dictionary table to be reverted back to a permanently stored initial master compression table (i.e., D_{MASTER}). In such an embodiment, each RSD 116′ can also be reverted back, as each RSD 116′ also has the same initial compression table stored therein.

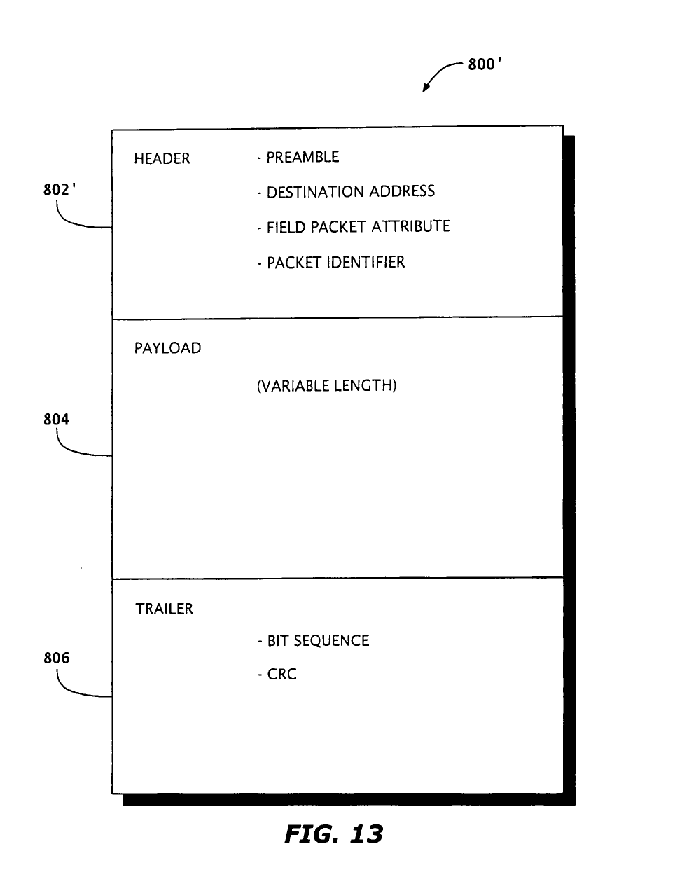

With reference to FIG. 13, in order to accommodate the above-described exemplary compression feature, an alternate embodiment of data structure 800, and header 802, in particular, is required. Accordingly, data structure 800′ includes a header field 802′, a payload field 804 and a trailer field 806. Header field 802′ is defined as having about nine bytes of information to reduce the overall transmission overhead. In an exemplary embodiment, header field 802′ suitably includes a preamble (e.g., a predefined bit sequence that identifies the beginning of a packet) having a length of about two bytes, a destination address (e.g., a one to four byte address of the data receiver), field packet attribute data (e.g., two or three bits identifying the packet as a data packet, control packet or the like, and identifying the type of compression used), and a packet identifier (e.g., a number that indicates the packet's place in a multi-packet data sequence and/or provides an initialization vector for a cryptography engine). It should be further noted that when compression is applied, compression begins with the first byte of the packet payload 804 and continues to and includes the CRC in trailer field 806. Additionally, in an exemplary embodiment, the above-described compression technique further requires that an additional “End of Data ESC” sequence be compressed and output at the very end of each packet to mark the end of the compression stream.

It should be noted that while only one exemplary compression technique was described in great detail above, the present invention is not so limited. Rather, other forms of compression can be used that remain within the spirit and scope of the present invention.

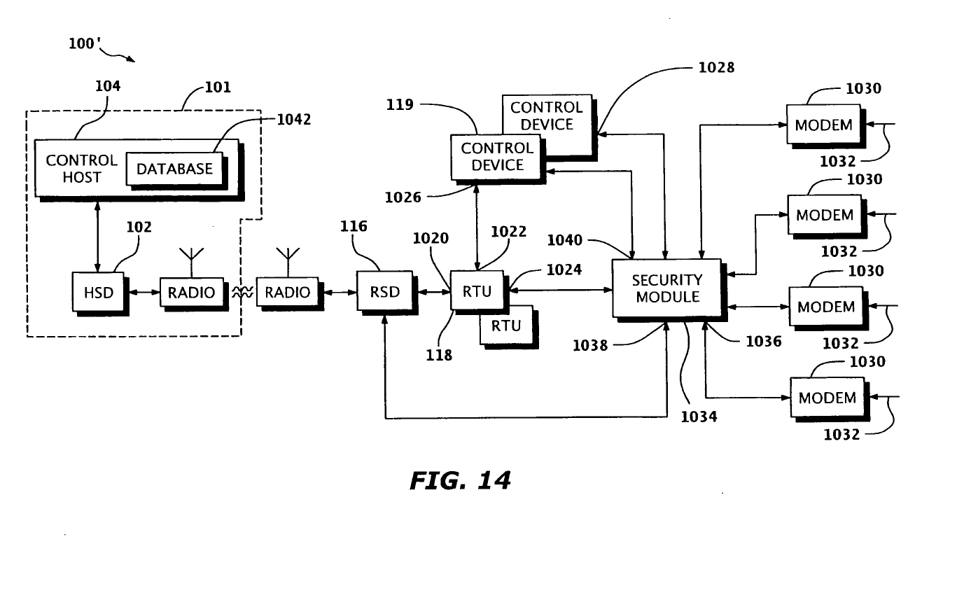

With reference now to FIGS. 14-18, and FIG. 14 in particular, in yet another alternate exemplary embodiment of SCADA system 100′, one or more remote devices, such as one or more RTUs 118 and/or the control devices (i.e., sensors, valves, switches or other types of field instrumentation to implement desired SCADA monitoring and/or control functions) to which RTUs 118 communicate (hereinafter referred to as control devices 119), are accessible remotely via one or more communication lines (i.e., telephone lines, in one exemplary embodiment) connected to modems that are coupled to RTUs 118 and/or control devices 119. In other words, these devices can be accessed through the “back-door” of the system (i.e., the opposite side of RTUs 118 from control host system 101, and therefore, control host 104 and HSD 102). Such an arrangement allows for maintenance personnel, for example, to perform maintenance or diagnostics on one or more of the RTUs 118 and/or control devices 119 without having to go through host 104 and/or HSD 102.

With continued reference to FIG. 14, each RTU 118 includes at least a first port 1020 that is configured for coupling to RSD 116, a second port 1022 configured for coupling to one or more of control devices 119 to allow for the transfer of SCADA information therebetween, and a third port 1024, different from both the first and second ports 1020, 1022, configured for coupling to a modem connected to one or more communication lines. Similarly, each control device 119 includes at least a first port 1026 configured for coupling to at least one RTU 118 to allow for the transmission of SCADA information therebetween, and a second port 1028, different from first port 1026, configured for coupling to a modem connected to one or more communication lines. Accordingly, in light of the above, in an exemplary embodiment system 100′ further includes one or more dial-up modems 1030 configured to connect one or more communication lines 1032, such as for example, telephone lines, with one or more remote devices, such as, for example, RTUs 118 and/or control devices 119.

In order to secure system 100′ from attacks originating through communication lines 1032 and modems 1030, as illustrated in FIG. 14, one or more security modules 1034 are logically placed between and coupled to one or more modems 1030 and the RTUs 118 and control devices 119 that communicate with modems 1030. Security module 1034 is configured to control access to the respective RTUs 118 and/or control devices 119 through the modems 1030 to which RTUs 118 and/or control devices 119 are coupled. Accordingly, the respective ports described above that allow for RTUs 118 and control devices 119 to be connected to modems 1030 are used to connect RTUs 118 and control devices 119 to security modules 1034 rather than directly to modems 1030. Security modules 1034 may be separate and distinct from modems 1030 (i.e., not within the same housing), or may be integrated with modems 1030 and thus housed within the same housing. For the purposes of explanation, an embodiment wherein security modules 1034 are separate and distinct from modems 1030 will be described hereinafter. Additionally, for the sake of simplicity of description, an embodiment having a single modem 1030 and a single security module 1034 will be described in greater detail below. It should be noted, however, that the present invention is not limited to such arrangements, rather a number of other arrangements having one or more modems and/or security devices remain within the spirit and scope the invention (i.e., in another embodiment, there are four modems 1030 that each feed into a single security module 1034).

In a preferred embodiment illustrated in FIG. 14, security module 1034 takes the form of a controller board that, at the most basic level, includes a printed circuit board, a processor and memory. In an exemplary embodiment, the processor of security module 1034 is configured to store one or more configurable operational parameters for security module 1034, as will be more fully described below. Security module 1034 further includes at least a first port 1036, a second port 1038 and a third port 1040. First port 1036 is configured to receive a line from modem 1030 and, in an exemplary embodiment, takes the form of a serial port configurable as an RS-232 interface (i.e., a data terminal equipment (DTE) port). Second port 1038 is configured for connection to RSD 116 (for purposes which will be described in greater detail below), and in an exemplary embodiment takes the form of a serial port configurable as an RS-232 interface (i.e., a data communications equipment (DCE) port). Third port 1040 is configured for connection to an RTU 118 or a control device 119 and, in an exemplary embodiment, takes the form of a serial port configurable as an RS-232 interface (i.e., a DTE port that is connected to port 1024 of RTU 118 or port 1028 of control device 119, as appropriate). In one exemplary preferred embodiment security module 1034 yet still further includes a fourth port, such as a serial port configurable as an RS-232 interface (i.e., a DTE port), for future use. While this preferred embodiment includes the aforementioned ports, it should be noted that it is contemplated that security module 1034 can be expanded to have more or less ports. For instance, in one embodiment, security module 1034 is configured to be coupled with four modems 1030, and thus, includes four of the “first” ports 1036. Similarly, as shown in FIG. 14, security module 1034 may be coupled to multiple RTUs 118 and/or control devices 119, and thus, may include a plurality of the “third” ports 1040. Accordingly, security modules having more or less ports than that described above remain within the spirit and scope of the present invention. It should be further noted that the specific types of ports set forth above are provided for exemplary purposes only and are not meant to be limiting in nature. Rather, one of ordinary in the art will recognize that any number of types of ports can be used, and thus, these types of ports remain within the spirit and scope of the present invention.

In operation, security module 1034 acts to intercept maintenance/diagnostic access calls to the modems 1030 placed on communication lines 1032 that are directed to one or more RTUs 118 and/or control devices 119. In an exemplary embodiment, security module 1034 requires the user initiating the call (i.e., maintenance personnel) to enter certain predetermined identification information, such as, for example, a valid user ID, a password, and/or other authenticating credentials, before being connected to the desired RTUs 118 and/or control devices 119. As will be described in greater detail below, in an exemplary embodiment, once the user inputs a user ID and password, the user ID and password are compared with authorized user information stored in a centralized user database 1042 to determine whether the user is authorized to access the desired equipment. It should be noted, however, that as briefly mentioned above, the required user identification information need not be limited to only a user ID and password, but rather other forms of authenticating credentials may be used. For example, in an alternate exemplary embodiment, the user will have a security device comprising a randomly changing numerical value that changes in synch with a corresponding/complementary changing numerical value residing within control host system 101 (i.e., in HSD 102 of control host system 101). These synchronized numerical values can also be used to authenticate a user.

If the user is authorized, security module 1034 serves as a pass-through to the corresponding RTUs 118 and/or control devices 119 that the user wishes to access, and the user can then interact with the menus thereof, for example. If, however, the user is not authorized, access to the corresponding RTUs 118 and/or control devices 119 is denied and the user is, for example, disconnected from the system or prompted to enter the correct user information.

In the exemplary embodiment illustrated in FIG. 14, the centralized user database 1042 is located within SCADA control host system 101, and in one exemplary embodiment, in control host 104 of host system 101. It should be noted, however, that in other exemplary embodiments, the user database 1042 may be stored in HSD 102 or external to control host system 101, such as, for example, in an LDAP server or Active Directory tree. In the particular embodiment wherein database 1042 resides within control host system 101, security module 1034 communicates with control host system 101 through the link between RSD 116 and HSD 102. Accordingly, security module 1034 sends information to RSD 116 through its second port 1038.

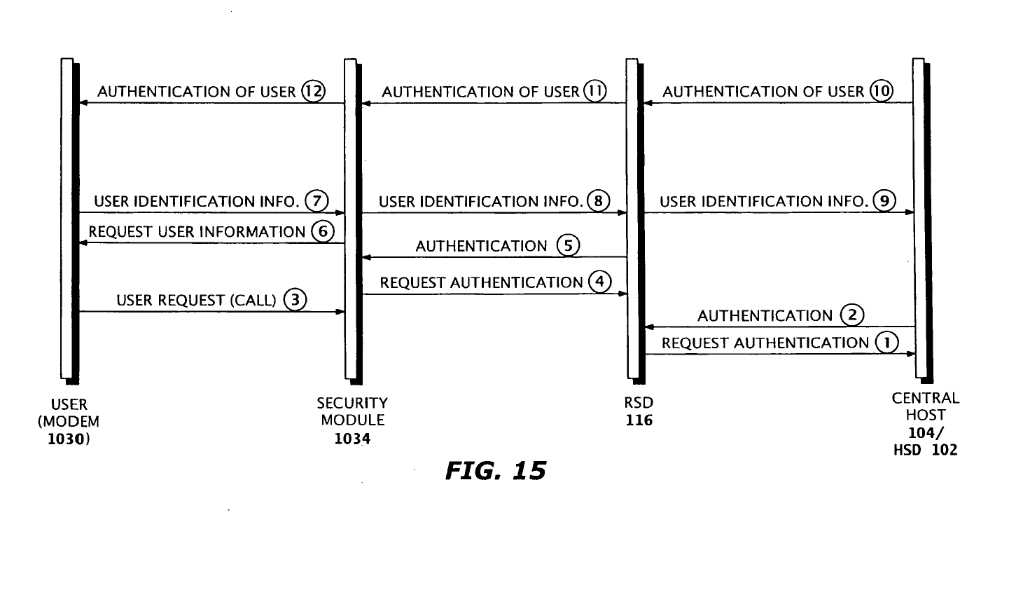

With reference to FIGS. 14 and 15, in order to operate as described above, several layers of authentication must occur (See, for example, FIG. 15, which shows in general and diagrammatic terms how a user is ultimately authenticated to access RTU 118 and/or control device 119). In no particular order, RSD 116 and control host system 101, or more particularly, HSD 102, must be authenticated with each other to allow for the exchange of information from the control host system 101 side of system 100′ to the remote side of system 100′. Second, security module 1034 and RSD 116 must be authenticated with each other to ensure that users attempting to gain access do so through a valid security module 1034. Third, the user itself must be authenticated with control host system 101 (i.e., the centralized user database 1042) to ensure the user seeking access is authorized to do so.

With respect to the authentication between the RSD 116 and HSD 102, the method of authentication described above is applicable hereto with full force and effect. Accordingly, in light of the detailed description of this method set forth above, this description will not be repeated here. When RSD 116 responds to the authentication process initiated by HSD 102, it also reports to HSD 102 the fact that a security module 1034 is present. HSD 102 then configures certain operational parameters of security module 1034 and sends the same to security module 1034 via RSD 116.

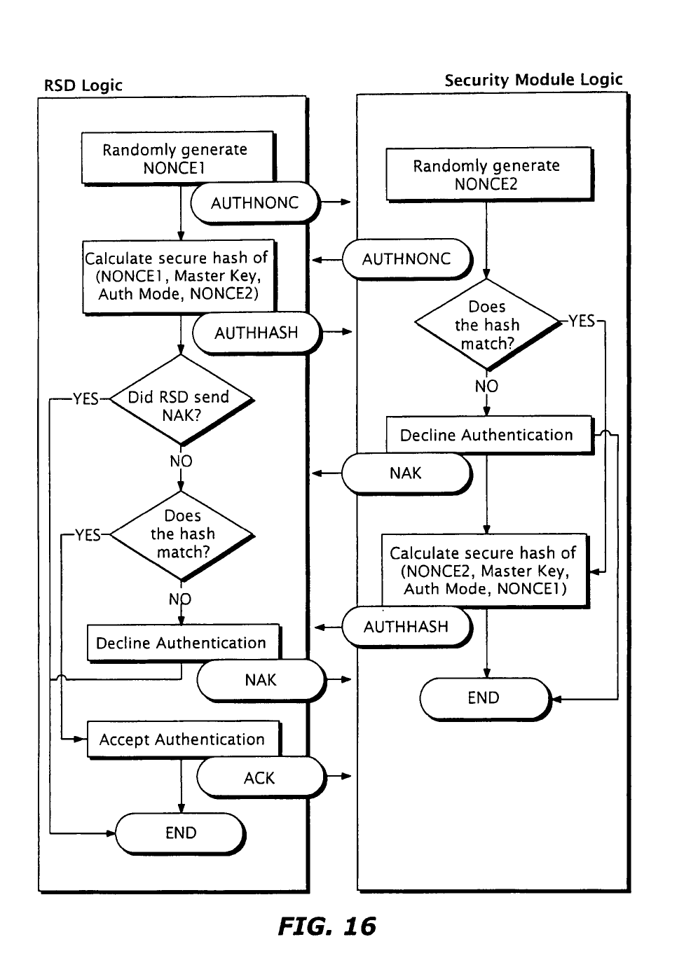

With respect to the authentication between the RSD 116 and security module 1034, in an exemplary embodiment, the known authentication process illustrated in FIG. 16, which employs a symmetric key model, is used. This process is similar to that described above with respect to the authentication of the RSD 116 and HSD 102. It should be noted, however, that the present invention is not limited to this process. Rather, those of ordinary skill in the art will appreciate that any number of authentication processes and techniques exist that can be used to carry out the authentication.

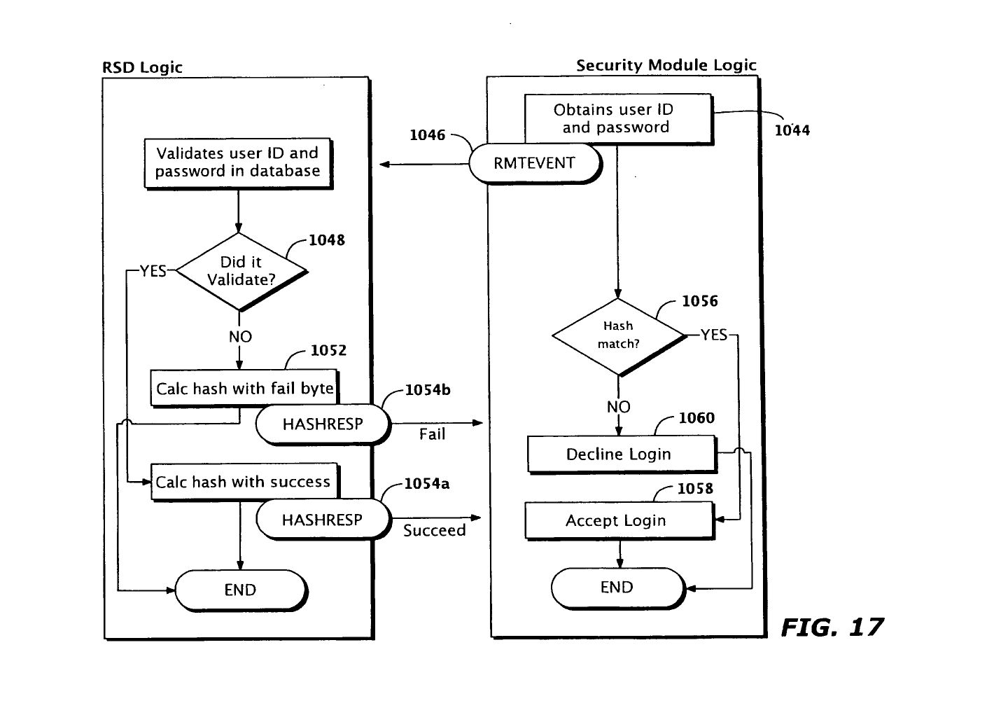

Once RSD 116 and security module 1034 are authenticated by the process illustrated in FIG. 16, for example, the user seeking access to the system is then authenticated as described generally above, and as specifically illustrated, in one exemplary embodiment, in FIG. 17. In a first step of this illustrated embodiment, security module 1034 collects the user identification information (i.e., user ID and password) from the user attempting to gain access, and calculates a hash of the password entered (step 1044). The password hash is encrypted with the master key shared by the control host system 101 (i.e., in centralized database 1042), the RSD 116 and the security module 1034. A packet having the arbitrary designation of RMTEVENT (i.e., which represents an event at the security module), for example, is then sent to the control host system 101, and HSD 102, in particular, to request login (step 1046). As described above, security module 1034 communicates with control host system 101 through RSD 116. Accordingly, RSD 116 simply acts as a relay means and passes the packets through from security module 1034 to control host system 101 (through HSD 102, if appropriate).

Once control host system 101 receives the RMTEVENT packet, control host system 101 looks up the user ID in the centralized user database and verifies that the password hash provided matches the password hash in the database (step 1048). In one exemplary embodiment, HSD 102 queries control host 104, in which centralized database 1042 is stored, as to whether the provided user ID and password are present in database 1042. If the password hashes match, control host system 101 (i.e., HSD 102) computes the hash of the user ID, the hash of the password, a byte signaling “success” and the master key (step 1050). If the password hash does not match, control host system 101 computes the hash of the user ID, the password hash, a byte signaling “failure” and the master key (step 1052). In either case, the hash is sent to security module 1034 with a HASHRESP packet (step 1054a or 1054b, respectively).

The security module 1034 is configured to validate that the password was successfully entered by computing the hash of the user ID, the password hash and the master key. The hash computed by security module 1034 is then compared with the hash sent in the HASHRESP packet (step 1056). If the hash from the HASHRESP packet matches this hash value, the login is accepted (step 1058), otherwise the login is denied (step 1060). It should be noted that while some of the communications passed from host 104 to the remote side of system 100′ (i.e., RSD 116, RTU 118, etc.) are encrypted and/or compressed (as discussed in great detail above), in an exemplary embodiment the communications relating to the authentication of a user attempting to gain access to the system through the process described above (i.e., communication line 1032 and modem 1030) are neither encrypted nor compressed. Once the user is authenticated with control host system 101, the user is granted access to the desired RTUs 118 and/or control devices 119 to perform the necessary testing, diagnostics, etc.

It should be noted, however, that while the above described process involved the provision of a user ID and password by the user, the present invention is not so limited. Rather, as briefly described above, numerous other forms of identification information corresponding to the user can be used to authenticate the user to the system. For example, in the alternate embodiment described above wherein synchronized randomly changing numeric values are used to authenticate the user in addition to a user ID and password, the following exemplary authentication process is carried out. The user inputs the user ID, the password and current numerical value from the user's security device. Once this information is received by security module 1034, the user ID is encrypted and a hash of the password and numerical value is computed as a single hash of both items. This information is then sent to control host system 101, and more specifically, HSD 102. Host system 101 then verifies the user name and hash for authentication. A response is then sent back security module 1034 that includes hashing over the user ID, password and numeric value, along with a success or failure indicator. Accordingly, one of ordinary skill in the art will appreciate that other authenticating credentials and/or authentication processes may be employed to carry out the authentication of the user to the system, all of which remain within the spirit and scope of the present invention.

In addition to authenticating the user, in an exemplary embodiment, control host system 101 is further configured to track and maintain a log(s) of various activities in the system. In an exemplary embodiment, control host system 101 is configured to track whether the various RTUs 118 and/or control devices 119 have a security module 1034 associated therewith, the number of lines for each security module 1034, the status of each line (i.e., active or inactive), the telephone number for each modem 1030, the incoming call schedule for each security module 1034 (i.e., the times at which the line is active and available to receive calls from modems 1030), the inbound telephone number for each security module 1034, and the communication settings for each control device 119 and/or RTUs 118, for example. In an exemplary embodiment, control host system 101 is further configured to log information relating to successful and failed login/authentication attempts between the particular user seeking access and the system. For example, control host system 101 logs the date and time the call was received, which security module was involved and the line that was dialed, the user ID given by the user and whether the login/authentication attempt was successful. Additionally, control host system 101 may also generate warning messages if certain activities take place. For instance, if a particular line is disabled and a login/authentication request occurs on that line, a warning message is generated and serves as notice that a hacking attempt may have set the parameters of the security module differently than control host system 101. In one exemplary embodiment, the aforementioned log(s) are maintained in HSD 102 or control host 104 of control host system 101, however, the present invention is not intended to be so limited. It should also be noted that this list of tracked/maintained information is not exhaustive, but rather is provided for exemplary purposes only. One of ordinary skill in the art will appreciate that the tracking and maintaining of other information may be desirable, and thus, remains within the spirit and scope of the present invention.

In an exemplary embodiment, control host system 101, and control host 104, in one exemplary embodiment, is still further configured to maintain various information relating to each user. For example, the following information for each authorized user is maintained: username, password, full name, indicators as to whether the user can log in remotely or not, indicators whether as to whether the user's account is active, password expiration dates, date/time of last login attempt, and date/time of last successful login, just to name a few. It should be noted, however, that this list of tracked information is not exhaustive, but rather is provided for exemplary purposes only. One of ordinary skill in the art will appreciate that the tracking and maintaining of other information may be desirable, and thus, remains within the spirit and scope of the present invention.

Additionally, as briefly described above, in an exemplary embodiment, security module 1034 further includes any number of configurable parameters to define how security module 1034 operates. In such an embodiment, control host system 101 (i.e., HSD 102 or control host 104), or whichever device is communicating/authenticating the user to the system, is capable of setting (i.e., programming and reprogramming) these configurable parameters. For exemplary purposes only, one such parameter is the “login retry limit,” which corresponds to the number of times the user is allowed to submit incorrect login information (i.e., user ID and password) before being disconnected from the system. Another parameter is the “login retry delays,” which corresponds to the amount of time between incorrect login attempts before another login attempt is permitted. Still another parameter is the “login timeout limit,” which defines the amount of total time permitted for login attempts. A similar parameter is the “idle timeout limit,” which defines the maximum amount of time a properly authenticated call may be idle before the user is disconnected. Yet still another parameter is the “user lock-out” parameter, which relates to denying access to or disconnecting a user from the system if the user is suspected of conducting suspicious activity. This parameter may also allow the system operator to change the user's password to prevent future access. A further exemplary parameter is the “line schedule” parameter and it allows the system operator to define when each dial-up line is active or inactive. In one embodiment, lines can be set to answer, to not answer, or to be busy during different time periods set by the system operator via control host 104.

The security module 1034 can further be configured to control the number of users having access at a certain time, or to control the level of access for different users. In one exemplary embodiment, security module 1034 is further configured to have a “call-back” mode of operation wherein if a user calls into the modem 1030, and thus the security module 1034, and the user is successfully authenticated, the system calls the user back to provide access to the desired RTUs 118 and/or control devices 119. It should be noted that while these specific parameters were expressly described, the list is by no means exhaustive. Rather, those of ordinary skill in the art will recognize that other parameters relating to security module 1034 and the operation thereof can be implemented and configured, and thus, remain within the spirit and scope of the invention.

It should be further noted that while much the description set forth above describes a system having a single security module 1034, the present invention is not so limited. Rather, in alternate embodiments, system 100′ may include multiple RSDs 116, RTUs 118, control devices 119, and security modules 1034 arranged in any number of ways. In these embodiments, the respective description set forth above applies with equal force to each corresponding component.

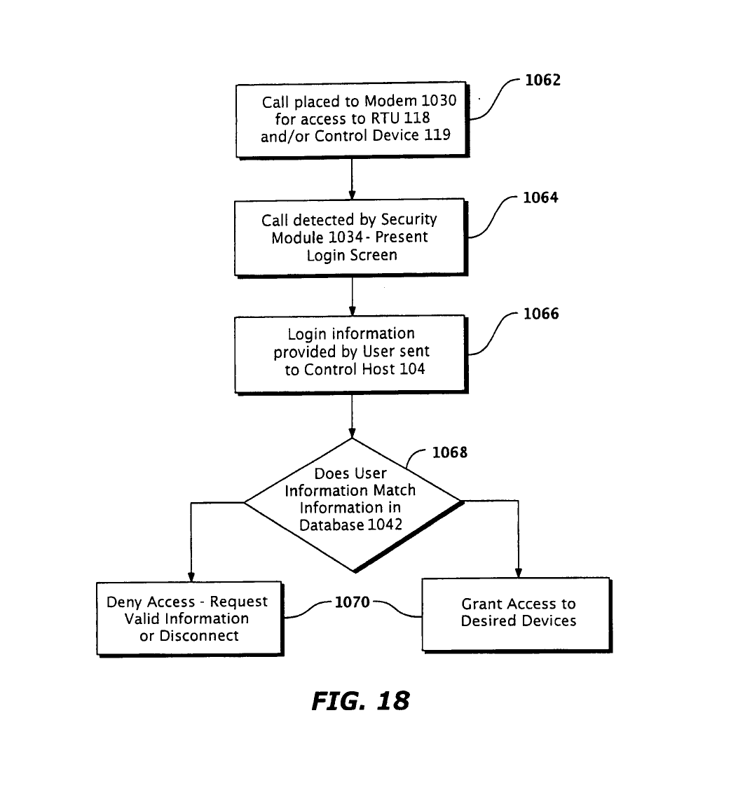

Accordingly, with reference to FIGS. 14 and 18, the above described system operates as follows. First, a user wishing to access one or more of the RTUs 118 and/or control devices 119 from the communication lines 1032 places a call to modem 1030 (step 1062). When this call is detected by security module 1034, security module 1034 presents the user with a login screen requesting a user ID and password (step 1064). Security module 1034 may also request information from the user relating to the particular RTUs 118 and/or control devices 119 that the user wishes to access. However, in an alternate embodiment, this request may be made following the user being authenticated to the system rather than during the authentication process. Once the user ID and password are provided, security module 1034 sends this information to control host system 101 (i.e., HSD 102) by way of RSD 116 (step 1066). Control host system 101, and in an exemplary embodiment HSD 102, compares the provided information against a database of authorized users stored in control host system 101 (step 1068). Control host system 101 then responds to security module 1034 and, depending on whether their was a match between the user provided information and that in the database, security module 1034 either grants the desired access to the user, or denies the desired access and either disconnects the user or requests that a valid user ID and/or password be provided (step 1070).

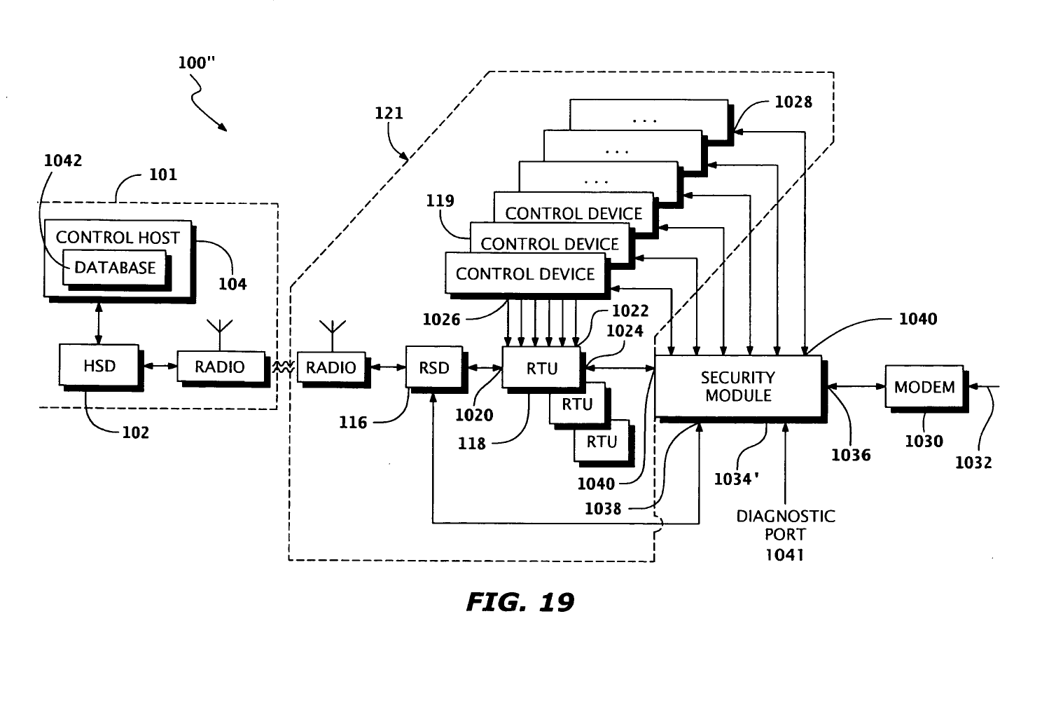

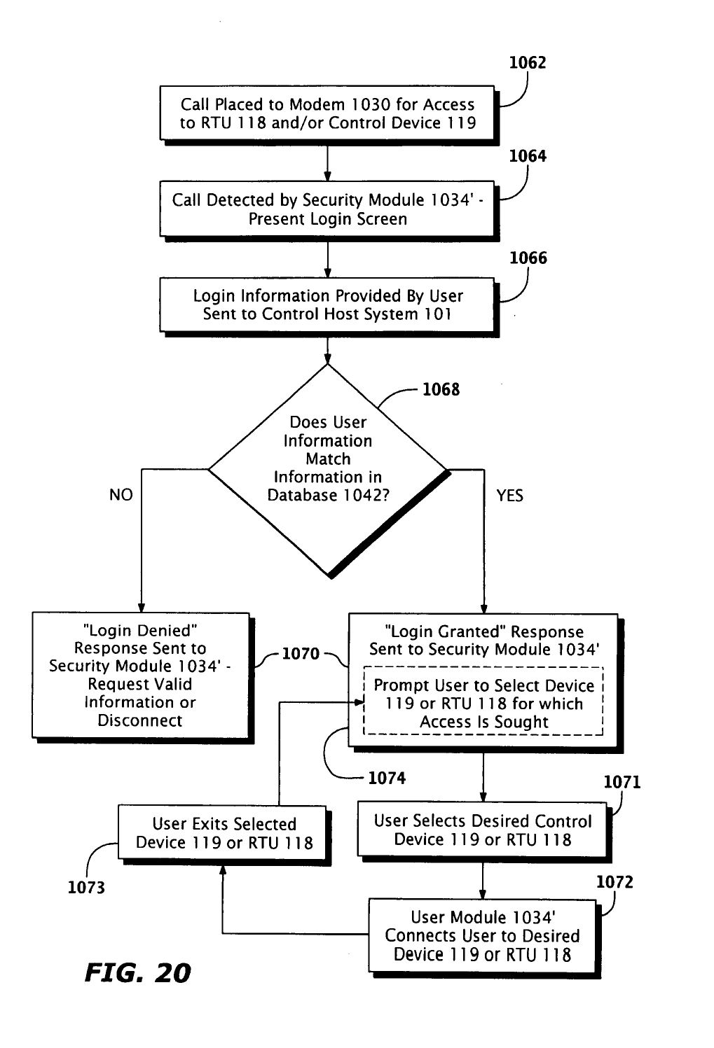

FIGS. 19 and 20 illustrate yet another alternate embodiment of SCADA system 100. In this embodiment, SCADA system 100″ includes a security module 1034′ that is configured for connection with a single modem 1030 and at least one device (i.e., an RTU 118 or control device 119). More likely, however, security module 1034′ is configured for connection with a plurality of devices, such as, for example, RTUs 118 and/or control devices 119. Except as expressly provided below, much of the above description of SCADA systems 100 and 100′ generally, and security module 1034 in particular, applies here with equal force, and thus, will not be repeated here.

As illustrated in FIG. 19, in this particular embodiment, security module 1034′ is configured to act as a line switch. More particularly, security module 1034′ is configured to communicate with a single modem 1030 and to direct a call received thereby, which is initiated by an authorized/authenticated user through modem 1030, to the appropriate RTU 118 or control device 119 based upon a user selection of available devices (if more than one device). Accordingly, in this embodiment, security module 1034′ includes a port 1036 for connection to modem 1030, at least one port 1038 for connection to RSD 116, a plurality of ports 1040 for connection to one or more RTUs 118 and/or control devices 119 (in an exemplary embodiment there are seven such ports configured to receive all RTUs 118, all control devices 119, or a combination thereof), and a fourth port 1041 that is designated for diagnostic use to allow for local access to security module 1034′. In one exemplary embodiment, each of the aforementioned ports are serial ports, and will take the form of either DTE ports or DCE ports as appropriate (i.e., in an exemplary embodiment, port 1036 is a DTE port, port 1038 is a DCE port, ports 1040 are DCE ports and port 1041 is a DCE port).

In operation, SCADA system 100″, and security module 1034′ in particular, operates as described above with respect to SCADA system 100′, with one slight difference. In this particular embodiment, once the user attempting to gain access to the system is properly authenticated and authorized to gain access to the devices thereof (i.e., as described above, the RSD is authenticated with the host, the security module is authenticated with the RSD, and the user is ultimately authenticated with the control host system, for example) and security module 1034′ receives a “login granted” response from control host system 101, security module 1034′ sends the user a menu of the available maintenance lines that the user is authorized to access (i.e., a listing of the RTUs 118 and/or control devices 119 that are connected to security module 1034′ and that the particular user is authorized to access). Alternatively, the user may be presented with all of the RTUs 118/control devices 119 on the system and invited to select the device the user wishes to access. Once the user makes a selection, system 100″ determines whether such access is permitted and then either allows or denies access accordingly. In either case, once the user selects a desired line that the user is allowed to access, security module 1034′ sends a signal to the chosen RTU 118 or control device 119 associated with the selected line to activate the menu system of RTU 118 or control device 119. Once the menu system is activated, security module 1034″ acts as a pass-through device, allowing the user to interact with the menus of the selected RTU 118 or control device 119. In an exemplary embodiment, if at any time the user wishes to exit out of the selected line, the user may do so by sending a predetermined command to security module 1034′ such as, for example, by performing/entering one or a combination of keystrokes. In this embodiment, once the user enters the predetermined command to exit out of the selected line, the user is once again presented the main menu of available devices by security module 1034′, at which time another device may be selected and accessed or, if there are no further devices that the user wishes to access, the user may select to end the session.

Accordingly, with reference to FIG. 20, in an exemplary embodiment the above described system operates as follows. First, a user wishing to access one or more of the RTUs 118 and/or control devices 119 from the communication line(s) 1032 initiates communication with security module 1034′ through modem 1030, such as, for example, by placing a call to security module 1034′ through modem 1030 (step 1062). When this call is detected by security module 1034′, security module 1034′ presents the user with a login screen requesting user identification information, such as, for example, a user ID and password (step 1064). It should be noted, however, that other identification credentials, such as those previously described above, may be used in addition to or in place of the use ID and password information. In addition to user identification information, security module 1034′ may also request information from the user relating to the particular RTU(s) 118 and/or control device(s) 119 that the user wishes to access. However, in an alternate embodiment this request may be made following the user being authenticated to the system rather than during the authentication/authorization process. Once the requested user identification information is provided, security module 1034′ sends this information to control host system 101 (i.e., HSD 102) by way of RSD 116 (step 1066). Control host system 101, and in an exemplary embodiment HSD 102, compares the provided information against a database of authorized users stored in control host system 101 (step 1068) to determine whether the user is authorized to access all or some of RTUs 118 and/or control devices 119. Control host system 101 then responds to security module 1034′ with a “login granted” or “login denied” response, thereby granting or denying access, respectively (step 1070). If the login is denied, in an exemplary embodiment, security module 1034′ either disconnects the user or requests that valid user identification information be provided. If the login is granted, security module 1034′ prompts the user to select the RTU 118 or control device 119 that the user wishes to access by presenting a menu of the available devices. Once the user selects the desired RTU 118 or control device 119 (step 1071), security module 1034′ connects the user to the desired device (step 1072). In an exemplary embodiment, if the user wishes to exit the selected device, the user enters one or more keystrokes, for example (step 1073), and security device 1034′ then presents the user with the main menu of available devices for the user to select a new RTU 118 or control device 119 to access (step 1074), or to choose to end the session.

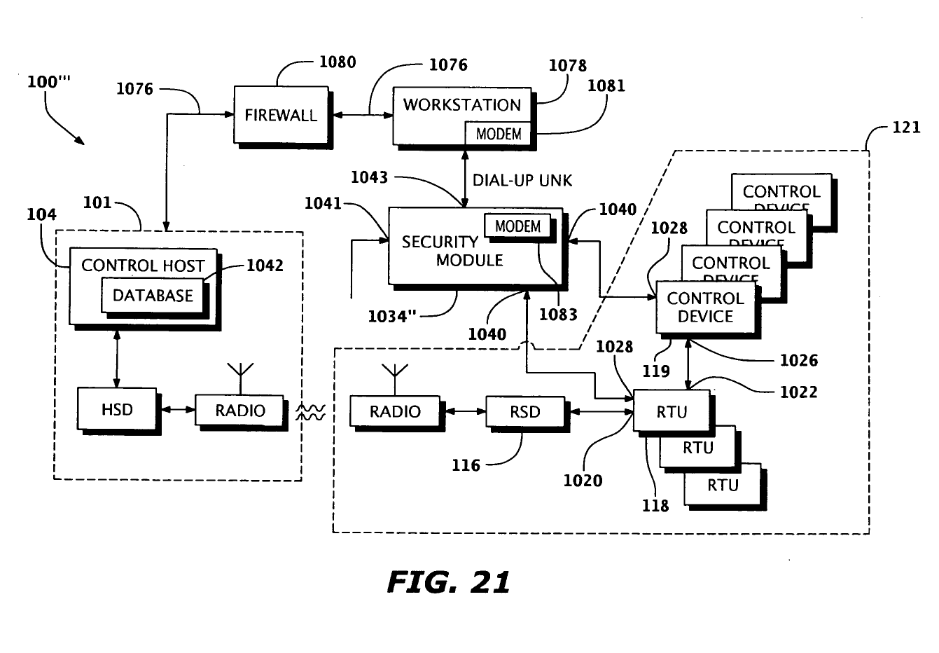

With respect to FIG. 21, yet still another alternate exemplary of a SCADA system 100 is illustrated. In this embodiment, SCADA system 100′″ includes an alternate way a remote user can gain access to one or more RTUs 118 and/or control devices 119 from those described above. As with SCADA system 100″, except as expressly provided below, most of the above descriptions of SCADA systems 100, 100′ and 100″, and their constituent components, applies here with equal force, and thus, a detailed description of these systems and components will not be repeated.

As illustrated in FIG. 21, in this embodiment, control host system 101 is configured to be connected to a network 1076, such as, for example, a local area network (LAN), a wide area network (WAN) or a Virtual Private Network (VPN). It should be noted, however, that this listing of networks is provided for exemplary purposes and is not meant to be limiting. Rather, those of ordinary skill in the art will recognize and appreciate that any number of types of networks may be utilized in accordance with the present invention. Also connected to network 1076 is a user workstation 1078, such as a personal computer, which allows a user to gain access to one or more remote devices, such as RTU(s) 118 and/or control device(s) 119. In this embodiment workstation 1078 and control host system 101 can communicate with each other over network 1076 in order to, for example, allow control host system 101 to authenticate/authorize a user operating workstation 1078 with SCADA system 100′″ such that the user may gain access to all or some of RTUs 118 and/or control devices 119 associated with system 100′″. In one exemplary embodiment, a firewall 1080 is connected within network 1076 and between control host system 101 and workstation 1078.

With continued reference to FIG. 21, in this exemplary embodiment, workstation 1078 is configured with software that allows it to communicate with security module 1034″, RTUs 118 and/or control devices 119 and control host system 101, for example, as well as to act as a conduit for allowing security module 1034″ to communicate with control host system 101. More specifically, the software installed on workstation 1078 allows for the user to initiate communications with security module 1034″ (such as, for example, to dial security module 1034″ from workstation 1078) and to then, as will be described below, provide a communication path across which control host system 101 and security module 1034″ can communicate to, for example, carry out the authorization/authentication process required to ultimately allow the user operating workstation 1078 to communicate with RTUs 118 and/or control devices 119. Accordingly, as is illustrated in FIG. 21, workstation 1078 with the accompanying software provides a communication path between security module 1034″ and control host system 101 that is independent of the link between the control host system 101 and the remote system 121 (i.e., between HSD 102 and RSD 116), which, in an exemplary embodiment is a radio link.

Accordingly, as with the embodiments described above, in this embodiment, RTU(s) 118/control devices 119 and security module 1034″ each include a plurality of ports to allow for the above described communication to be implemented. For instance, RTU(s) 118/control devices 119 each include at least one port 1028 that is configured to be connected to corresponding ports 1040 of security module 1034″. RTU(s) 118 further include at least one port 1020 that is configured to be connected to RSD(s) 116 and through which SCADA information can be communicated therebetween. RTU(s) 118 still further include at least one port 1022 that is configured to be connected to a corresponding port 1026 of control device(s) 119 such that SCADA information can be communicated therebetween. In addition to port(s) 1040, security module 1034″ further includes at least one port 1043 that is configured for coupling to workstation 1078, and may include at least one port 1041 that is configured to allow for access to security module 1034″ for diagnostic purposes. As with the previously described embodiments, in an exemplary embodiment, each of the aforementioned ports are serial ports. However, the present invention is not so limited and other types of ports remain within the spirit and scope of the present invention.

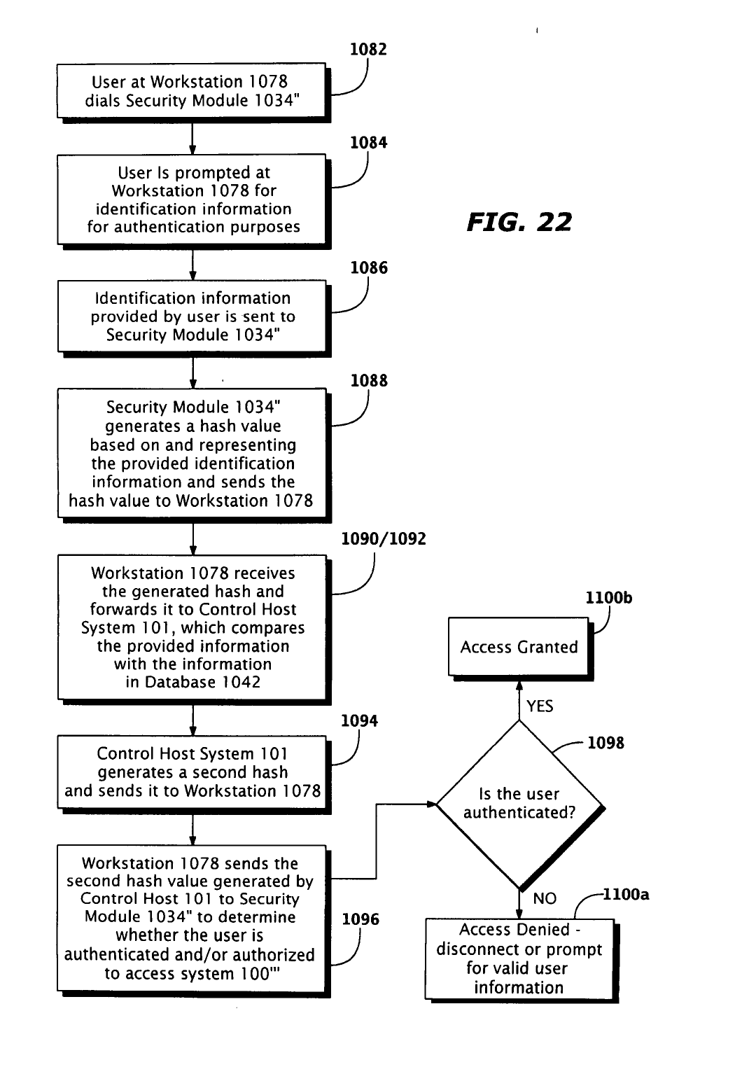

With reference to FIGS. 21 and 22, the operation of the illustrated embodiment will now be described. First, using the aforementioned software installed on workstation 1078, a user operating workstation 1078 initiates communication with security module 1034″ to establish a link between workstation 1078 and port 1043 of security module 1034″ (step 1082). In one exemplary embodiment, workstation 1078 and security module 1034″ each include a modem 1081 and 1083, respectively, that are either internal or external to workstation 1078 and security module 1034″. Accordingly, in an exemplary embodiment, through workstation 1078, and modem 1081 in particular, the user initiates a call via the software on workstation 1078 to attempt to establish a dial-up link between modem 1081 and modem 1083 of security module 1034″.

In this particular embodiment, if security module 1034″ answers the call, a dial-up link is established, and the user is then prompted at workstation 1078 by security module 1034″ for certain predetermined identification information, such as, for example, a valid user ID, a password and/or other authenticating credentials, such as, for example, a randomly changing numerical value that changes in synch with a corresponding/complementary changing numerical value residing within control host system 101 (step 1084). Also, in addition to the user identification information, in an exemplary embodiment, the user may also be prompted to provide information on the RTUs 118 and control devices 119 that the user wishes to access to determine, for example, whether the user is not only authorized to access system 100′″, but also whether the user is authorized to access the particular device(s) the user wishes to access. Alternatively, the user may be presented with a listing of all of the RTUs 118/control devices 119 on the system and invited to select the device the user wishes to access. Once the user makes a selection, system 100′″ determines whether such access is permitted and then either allows or denies access accordingly.

Once the required identification information is entered, and if applicable the desired device information, the information is sent to security module 1034″ (step 1086). Security module 1034″ receives and processes the provided identification information and then generates a signal representing the provided information to be sent to control host 101. In one exemplary embodiment, the generated signal comprises a hash value that is generated using the provided identification information. Additionally, in an exemplary embodiment, the signal generated by security module 1034″ is first sent to workstation 1078, which then sends the signal on to control host system 101 across network 1076. Accordingly, in an exemplary embodiment, once the hash value corresponding to the user-provided information is generated, it is sent from security module 1034″ back to workstation 1078 over the dial-up link (step 1088). When workstation 1078 receives the generated hash, it forwards it on to control host system 101 over network 1076 for authentication/authorization (step 1090).

As described in greater detail above, once the signal (i.e., the hash) is received, control host system 101 compares the provided user information represented by the hash with user information stored in database 1042 located in control host system 101, or remote thereto, in order to determine whether the user attempting to gain access to SCADA system 100′″ and the devices associated therewith through workstation 1078 is authorized to do so (step 1092). Once this comparison is complete, control host system 101 generates a signal, such as, for example, a second hash representing whether the user is authorized to access system 100′″ and/or all or some of RTUs 118 and/or control devices 119, and then sends the second hash to workstation 1078 (step 1094). Workstation 1078 then transmits the second hash from control host system 101 to security module 1034″ over the dial-up link (step 1096). It should be noted that although workstation 1078, and ostensibly the user, is participating in the authentication process and the communication of the respective hash values, in particular, it is not possible for the user or workstation 1078 to modify or otherwise alter the hash values in an effort to force a valid login. Rather, correct hash values may only be generated by the control host system 101 or security module 1034″. Thus, workstation 1078 has a passive role in the authentication/authorization process and merely acts as a conduit of information between security module 1034″ and control host system 101.

Once security module 1034″ receives the second hash value that was generated by control host system 101, security module 1034″ is configured to determine whether or not a “login” was granted by control host 101, and thus, whether access was granted to the user (step 1098). In one exemplary embodiment, if security module 1034″ determines that the user is not authorized to gain access, security module may respond in a number of ways. For example, security module 1034″ may simply send a message to workstation 1078 advising that access is denied (step 1100a). Alternatively, security module 1034″ may send the aforementioned message and then prompt the user to enter valid user information. Still further, security module may simply disconnect workstation 1078, thereby ending the dial-up link.

If, on the other hand, security module 1034″ determines that the user is, in fact, authenticated/authorized to gain access to SCADA system 100′″ and RTU(s) 118 and/or control device(s) 119 associated therewith, security module 1034″ initiates a secure session with workstation 1078, which, in one exemplary embodiment, employs 2048 bit encryption. Once the session is initiated, security module 1034″ acts as a pass-through allowing the user to communicate directly with certain or all of RTU(s) 118 and/or control devices 119 (step 1100b) through the respective ports of each device. In an exemplary embodiment, the user is granted access to all devices connected to security module 1034″. However, in an alternate embodiment, the user may be limited in the devices and/or types of devices that are accessible, or, as was described above with respect to SCADA system 100″, may be prompted to select which device(s) the user wishes to access. In such an instance, once the user makes a selection, system 100′″ will then determine whether the user is permitted to access the desired device.

One exemplary advantage to the alternate embodiment illustrated in FIGS. 21 and 22 as compared to SCADA system 100′ and 100″ above, is that the communication path between security module 1034″ and control host 101, and therefore the authentication/authorization process, is not dependent on the link between control host system 101 and remote system 121 (i.e., the radio link between HSD 102 and RSD 116) being operational. Accordingly, in this embodiment, should the link between control host system 101 and the corresponding remote systems 121 (i.e., the link between HSD 102 and RSD 116, for example) become disabled or otherwise unavailable, the user can still access the RTUs 118 and/or control devices 119 in order to troubleshoot or to perform diagnostics, for example, since the authentication/authorization process is independent of this link.

While certain exemplary embodiments have been presented in the foregoing detailed description, it should be appreciated that a vast number of variations exist. The various security modules, for example, may be incorporated into SCADA hosts and/or remote terminals, and may be implemented as hardware and/or software “devices” in a wide array of equivalent embodiments. Moreover, the various cryptographic techniques set forth herein could be supplemented, modified or replaced with any other processes or steps. It should also be appreciated that the exemplary embodiments set forth herein are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements and steps described without departing from the scope of the invention as set forth in the appended claims and their legal equivalents.

1. A secure supervisory control and data acquisition (SCADA) system, comprising:
a SCADA control host system configured to process SCADA information;
a remote device configured to communicate SCADA information with said control host system;
a modem coupled between said remote device and a communication line, wherein said modem is configured to allow for communication between said remote device and said communication line; and
a security module coupled between said modem and said remote device, said security module being configured to control access to said remote device by a user seeking access thereto from said communication line through said modem.

2. A SCADA system in accordance with claim 1 wherein said security module is configured to control access by requesting and receiving user identification information from said user through said modem, which is then compared with authorized user identification information stored in a centralized user database.

3. A SCADA system in accordance with claim 2 wherein said centralized user database is stored in said control host system and said user information provided to said security module is communicated to said control host system for comparison with said information stored in said centralized database.

4. A SCADA system in accordance with claim 1 wherein said control host system includes a host security device (HSD) coupled to a control host, said SCADA system further comprising:
a remote security device (RSD) coupled to said remote device;
said HSD and said RSD are configured to establish secure communications between said control host and said remote device such that said HSD is configured to encrypt SCADA information received from said control host and to decrypt encrypted SCADA information that is encrypted by and received from said RSD, and said RSD is configured to encrypt SCADA information received from said remote device and to decrypt encrypted SCADA information that is encrypted by and received from said HSD.

5. A SCADA system in accordance with claim 4 wherein said security module is coupled to and configured for communication with said RSD so as to allow communication between said security module and said control host system.

6. A SCADA system in accordance with claim 1 wherein said system includes a plurality of remote devices.

7. A SCADA system in accordance with claim 6 wherein said security module is configured to allow said user to select which of said plurality of remote devices said user wishes to access.

8. A SCADA system in accordance with claim 7 wherein said security module is further configured to allow said user to switch from a first one of said plurality of remote devices to a second one of said plurality of remote devices, thereby allowing said user to access multiple ones of said plurality of remote devices.

9. A method of securing a supervisory control and data acquisition (SCADA) system, comprising the steps of:
providing a SCADA control host system configured to process SCADA information;
providing a remote device configured to communicate SCADA information with said control host system;
providing a modem coupled between said remote device and a communication line wherein said modem is configured to allow for communication between said remote device and said communication line;
providing a security module coupled between said modem and said remote device to control access to said remote device by a user seeking access thereto from said communication line;
receiving, at said security module, predetermined user identification information provided by said user through said modem;
comparing said user identification information with authorized user information stored in a centralized user database located within said system;
if said provided user identification information matches said authorized user information, allowing access to said selected remote device, otherwise denying access.

10. A method in accordance with claim 9 wherein:
said providing a control host system step includes providing a control host system comprising a control host coupled to a host security device (HSD); and
said method further including providing a remote security device (RSD) coupled to said remote device to allow for communication of SCADA information therebetween, wherein said HSD and said RSD are configured to establish secure communications between said control host system and said remote device, said RSD further coupled to said security module to allow for said security module to communicate with said control host system.

11. A method in accordance with claim 9 wherein said providing a control host system step includes providing a control host system in which said centralized user database is located, said method further comprising:
sending said user information provided by said user at said security module to said control host system through said RSD for comparison with said authorized user information in said centralized database to authenticate said user.

12. A method in accordance with claim 9 wherein said providing a remote device step comprises the substep of providing a plurality of remote devices, said method further comprising the step of:
prompting, by said security module, said user to select one of said plurality of remote devices for which access is sought.

13. A method in accordance with claim 12 wherein said method further comprises the step of:
terminating access to said selected one of said plurality of remote devices;
prompting said user, by said security module, to select a second one of said plurality of remote devices which said user wishes to access; and
granting access to said second one of said plurality of remote devices.

14. A secure supervisory control and data acquisition (SCADA) system, comprising:
a SCADA control host system configured to process SCADA information;
a remote device configured to communicate SCADA information with said control host system;
a workstation configured to communicate with said control host system and said remote device; and
a security module coupled between said workstation and said remote device, said security module being configured to control access to said remote device by a user operating said workstation.

15. A SCADA system in accordance with claim 14 wherein said security module is configured to control access to said remote device by requesting and receiving user identification information from said user through said workstation which is then compared with authorized user information stored in a centralized database.

16. A SCADA system in accordance with claim 15 wherein said centralized database is stored in said control host system and said security module is configured to send said user identification information to said control host system.

17. A SCADA system in accordance with claim 14 wherein said control host system includes a host security device (HSD) coupled to a control host; said SCADA system further comprising:
a remote security device (RSD) coupled to said remote device;
said HSD and said RSD configured to establish secure communications between said control host and said remote device such that said HSD is configured to encrypt SCADA information received from said control host and to decrypt encrypted SCADA information that is encrypted by and received from said RSD, and said RSD is configured to encrypt SCADA information received from said remote device and to decrypt encrypted SCADA information that is encrypted by and received from said HSD.

18. A SCADA system in accordance with claim 14 further comprising a network, wherein said control host system and said workstation are connected to said network to allow for communication therebetween.

19. A SCADA system in accordance with claim 14 wherein said system includes a plurality of remote devices.

20. A SCADA system in accordance with claim 19 wherein said security module is configured to prompt said user to select which one of said plurality of remote devices said user desires to access.

21. A method of securing a supervisory control and data acquisition (SCADA) system, comprising the steps of:
providing a SCADA control host system that is connected to a network wherein said control host system is configured to process SCADA information;
providing a remote device configured to communicate SCADA information with said control host system;
providing a workstation connected to said network and configured to communicate with said control host system and said remote device;
providing a security module coupled between said workstation and said remote device configured to communicate with said workstation to control access to said remote device by a user operating said workstation;
receiving, at said security module, predetermined said user identification information provided by said user at said workstation;
comparing said user identification information with authorized user identification information stored in a centralized user database;
allowing access to said remote device if said user information matches said authorized information, otherwise denying access to said remote device.

22. A method in accordance with claim 21 wherein:
said providing a control host system includes providing a control host system in which said centralized database is stored;
said method further including the step of sending said user identification information from said security module to said control host system for comparison with said authorized user information stored in said centralized database.

23. A method in accordance with claim 22 wherein said sending said user identification information to said control host system step includes sending said user identification information to said workstation, which then, in turn, transmits said user identification information to said control host system over said network.

24. A method in accordance with claim 21 wherein said providing a remote device comprises providing a plurality of remote devices, said method further comprising the step of:
prompting, by said security module, said user at said workstation, prior to allowing access to said remote devices, to select one of said plurality of remote devices for which access is sought.

25. A method in accordance with claim 24 wherein said method further includes the steps of:
terminating access to said selected one of said plurality of remote devices;
prompting said user, by said security module, to select a second one of said plurality of remote devices which said user wishes to access; and
granting access to said second one of said plurality of remote devices.
